(19) United States
(12) Patent Application Publication
(10) Pub. No.: US 2025/0172661 A1
(43) Pub. Date: May 29, 2025

(54) SPEED DETECTION APPARATUS, INFORMATION PROCESSING DEVICE, AND INFORMATION PROCESSING METHOD

(71) Applicant: Sony Semiconductor Solutions Corporation, Kanagawa (JP)

(72) Inventor: Ryo Sasaki, Kanagawa (JP)

(21) Appl. No.: 18/696,581

(22) PCT Filed: Sep. 15, 2022
(86) PCT No.: PCT/JP2022/034498

§ 371 Date: Nov. 26, 2024

(30) Foreign Application Priority Data
Nov. 9, 2021 (JP) 2021-182461

(51) Int. Cl. G01S 7/35; G01S 7/03; G01S 13/58

(52) U.S. Cl. CPC G01S 7/356; G01S 7/03; G01S 13/583

(57) ABSTRACT

[Object] To achieve a wide speed expansion range.

[Solving Means]A speed detection apparatus includes: a chirp control unit that controls a plurality of chirp signals transmitted from a plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and a speed determination unit that calculates, on the basis of the plurality of reflected chirp signals received by the plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra, M representing a natural number of one or greater.

### TECHNICAL FIELD

The present disclosure relates to a speed detection apparatus, an information processing device, and an information processing method that use a frequency modulated continuous wave (FMCW) radar.

### BACKGROUND ART

In a multi input multi output (MIMO) radar, a plurality of transmission antennas transmits chirp signals in groups called bursts. A reception antenna receives the reflected chirp signal. The received signal is downconverted, digitized, and then processed to obtain distances, speeds, and arrival angles of a plurality of objects in front of the radar. The chirp signal is a signal whose frequency varies linearly over time. Time division multiplexing (TDM), binary phase multiplexing (BPM), and the like are known as methods of ensuring orthogonality of signals transmitted from the plurality of transmission antennas.

### CITATION LIST

### Patent Literature

Patent Literature 1: Japanese Unexamined Patent Application Publication No. 2019-522220

### DISCLOSURE OF INVENTION

### Technical Problem

A speed detection range (referred to also as an observable speed) in which a radar detects a speed is limited. The MIMO radar has a characteristic of a low observable speed. In the case where a target with a speed exceeding the observable speed is detected, it is detected as a false speed instead of being invisible because it is out of the observable speed. Due to the detection of a false speed, problems such as occurrence of ghosts, misrecognition, and reduction in electric power occur in some cases. The observable speed of the radar is obtained by the following formula.

$$Vmax = λ / ( 4 \times TB ) [ m / s ] \qquad ( 10 )$$

Vmax is the maximum value of the observable speed, λ is the wavelength, and TB is the burst interval between chirps for calculating the speed. Since the burst interval TB is defined as the interval between chirp signals from the same antenna, the burst intervals T is represented by N×Tc in the MIMO radar in which chirps are applied from a plurality of transmission antennas in time division or phase division, and the formula (10) is further represented as follows.

$$Vmax = λ / ( 4 \times N \times Tc ) [ \text{m/s} ] \qquad ( 11 )$$

N is the number of the plurality of transmission antennas and Tc is an interval between chirp signals. As is clear from the formula (11), TB increases and Vmax decrease as N increases. This is the reason why the observable speed is low in the MIMO.

In this regard, as one method of expanding the speed detection range, a method using an angle of arrival (AoA) is known as shown in Patent Literature 1. The metho using AoA utilizes the reduction in electric power due to a directivity deviation (false speed) caused by a speed phase difference between transmission antennas in the MIMO. MIMO speed phase correction and AoA are performed on the plurality of possible speeds, and a speed candidate with larger electric power is used as a true speed.

By expanding the speed, there are advantages that the true speed can be detected even if the speed wraps and reduction in electric power, occurrence of ghosts, misdetection, and the like can be prevented by knowing the true speed. In particular, the method using AoA has an additional advantage that the frame rate does not drop because a plurality of modes is not used, but has disadvantages that the speed expansion range is narrow (in the case where the number of transmission antennas is two, it expands only to the extent of the observable speed in the case where the number of transmission antennas is one), it is limited to the MIMO, and the like.

Incidentally, as a scene where an observable speed of a moving object such as a vehicle is required, assumption is made that the own vehicle is traveling at 60 km/h and an oncoming vehicle is traveling at −60 km/h. At this time, an observable speed up to −120 km/h is required for the own vehicle to detect the oncoming vehicle, and an observable speed up to −60 km/h is required to detect a stationary object such as a tunnel.

Although an observable speed of approximately ±120 km/h is required even on ordinary roads, a typical method using AoA has a disadvantage that the observable speed can be expanded only from approximately ±40 km/h to 80 km/h.

In view of the circumstances as described above, it is desirable to obtain a wide speed expansion range even in the method using AoA.

### Solution to Problem

A speed detection apparatus according to an embodiment of the present disclosure includes:
a transmission antenna array that transmits a plurality of chirp signals multiplexed between a plurality of transmission antennas;
a reception antenna array that includes a plurality of reception antennas receiving the plurality of chirp signals that has been reflected;
a chirp control unit that controls the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on a basis of the plurality of reflected chirp signals received by the plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra, M representing a natural number of one or greater.

In accordance with this embodiment, since when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal, it is possible to expand the observable speed to be wider than the speed range in the equidistant MIMO.

The chirp control unit multiplexes the plurality of chirp signals between the plurality of transmission antennas such that

$$TcL / TB > 1 / N$$

is satisfied,
TcL representing the longest interval of the intervals Tc between the plurality of chirp signals from the different transmission antennas.

In accordance with this embodiment, since TcL/TB>1/N, it is possible to expand the observable speed to be wider than the speed range of the equidistant MIMO.

The chirp control unit may multiplex the plurality of chirp signals between the plurality of transmission antennas in time division.

The chirp control unit may multiplex the plurality of chirp signals between the plurality of transmission antennas in phase division.

This embodiment is applicable to both the time division MIMO and the phase division MIMO.

The transmission antenna array and the reception antenna array may constitute a horizontal MIMO array.

The transmission antenna array and the reception antenna array may constitute a vertical MIMO array.

The vertical MIMO array may be a vertical MIMO array with equal intervals.

This embodiment is applicable to both the horizontal MIMO array and the vertical MIMO array. In particular, since the intervals for transmitting chirp signals are unequal, this embodiment is applicable also to the vertical MIMO with equal intervals.

The speed determination unit may perform arrival angle estimation by fast Fourier transform (FFT) or discrete Fourier transform (DFT).

This embodiment is applicable to both FFT and DFT.

The speed determination unit may perform arrival angle estimation by CAPON, MUSIC, ESPRIT, or compression sensing.

The speed determination unit may calculate M speed candidates from a plurality of possible speed candidates that can be taken in a speed width 2×Vmax×Nwrap obtained by Nwrap (Nwrap>N) and Vmax, Nwrap×(TcL/TB) being an integer multiple, M being larger than N. Here, Nwrap is the number of speed wraps.

The speed determination unit may select and determine a speed at which a main lobe takes a maximum value, of the M arrival angle spectra, from the M speed candidates.

The speed determination unit may select and determine a speed at which a ratio between a main lobe and a side lobe takes a maximum value, of the M arrival angle spectra, from the M speed candidates.

An information processing device according to an embodiment of the present disclosure includes:
a chirp control unit that controls a plurality of chirp signals transmitted from a plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on a basis of the plurality of reflected chirp signals received by a plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra,
M representing a natural number of one or greater.

An information processing method according to an embodiment of the present disclosure includes:
controlling, in a speed detection apparatus that includes
   a transmission antenna array that transmits a plurality of chirp signals multiplexed between a plurality of transmission antennas, and
   a reception antenna array that includes a plurality of reception antennas receiving the plurality of chirp signals that has been reflected,
the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal;
calculating, on a basis of the plurality of reflected chirp signals received by the plurality of reception antennas, M speed candidates faster than a maximum speed Vmax obtained from the intervals TB;
acquiring M arrival angle spectra by performing phase error correction and arrival angle estimation on the M speed candidates; and
determining a true speed by processing the M arrival angle spectra,
M representing a natural number of one or greater.

### BRIEF DESCRIPTION OF DRAWINGS

FIG. 1 schematically shows the concept of the horizontal MIMO.

FIG. 2 schematically shows the concept of the vertical MIMO.

FIG. 3 schematically shows the concept of the TDM-MIMO.

FIG. 4 schematically shows the concept of speed phase error correction of the TDM-MIMO.

FIG. 5 schematically shows the concept of speed phase error correction of the TDM-MIMO.

FIG. 6 schematically shows the concept of the limitation of speed phase correction due to speed ambiguity.

FIG. 7 schematically shows the concept of the limitation of speed phase correction due to speed ambiguity.

FIG. 8 shows correction of a phase difference due to speed ambiguity.

FIG. 9 shows correction of a phase difference due to speed ambiguity.

FIG. 10 schematically shows a case where transmission timings of chirp signals are equal intervals.

FIG. 11 schematically shows a difference between the technology according to this embodiment and a typical technology.

FIG. 12 schematically shows transmission timings of chirp signals according to this embodiment (horizontal MIMO array).

FIG. 13 shows transmission timings of phase differences between chirp signals for an integer multiple and a non-integer multiple.

FIG. 14 shows a wrap period.

FIG. 15 shows arrival angle spectra of a plurality of speed candidates in a typical example (horizontal MIMO array).

FIG. 16 shows arrival angle spectra of a plurality of speed candidates in this embodiment (horizontal MIMO array).

FIG. 17 shows an Example (time division) of this embodiment.

FIG. 18 shows another Example (phase division) of this embodiment.

FIG. 19 schematically shows an Example of the concept of the vertical MIMO.

FIG. 20 schematically shows transmission timings of chirp signals according to this embodiment (vertical MIMO array).

FIG. 21 shows arrival angle spectra of a plurality of speed candidates in this embodiment (vertical MIMO array).

FIG. 22 shows arrival angle spectra of a plurality of speed candidates in a typical example (vertical MIMO array).

FIG. 23 is a block diagram showing a configuration of a speed detection apparatus according to this embodiment.

FIG. 24 is a block diagram showing a configuration example of a vehicle control system.

FIG. 25 is a diagram showing an example of a sensing region.

### MODE(S) FOR CARRYING OUT THE INVENTION

An embodiment of the present disclosure will be described below with reference to the drawings.

### 1. Overview of Typical Technology

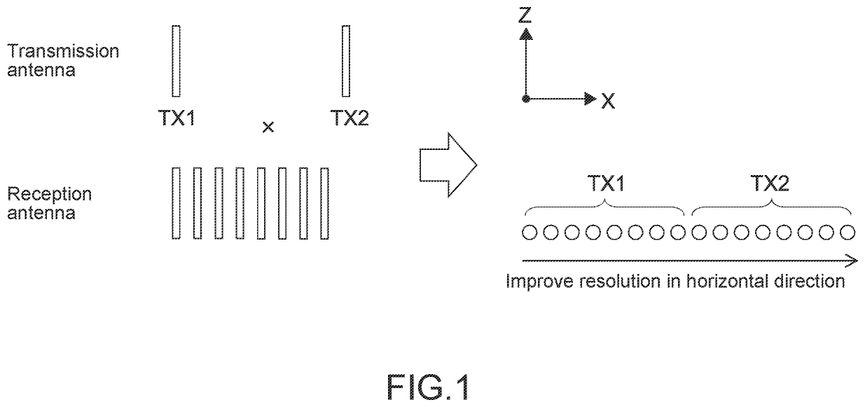

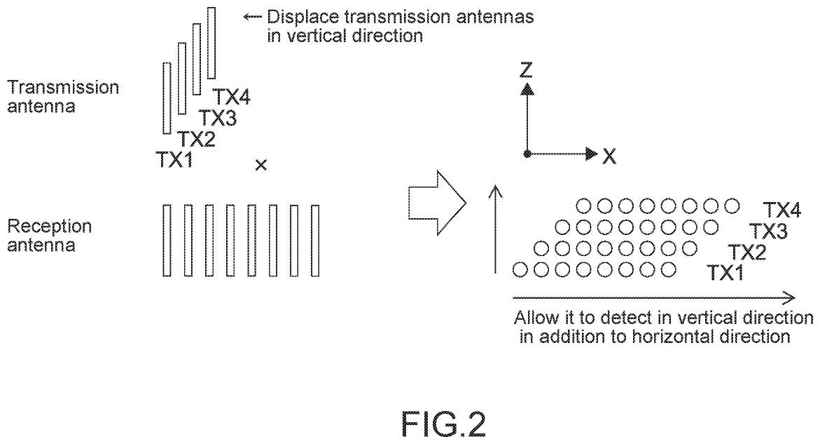

FIG. 1 schematically shows the concept of the horizontal MIMO. FIG. 2 schematically shows the concept of the vertical MIMO.

The MIMO is a method of virtually increasing the opening length (≈reception area of the antenna) by spatially displacing a plurality of (two in this example) transmission antennas with respect to a plurality of (eight in this example) reception antennas. Displacing a plurality of transmission antennas in the horizontal direction improves the resolution in the horizontal direction (FIG. 1). Displacing a plurality of transmission antennas in the vertical direction improves the resolution in the vertical direction in addition to the horizontal direction (FIG. 2).

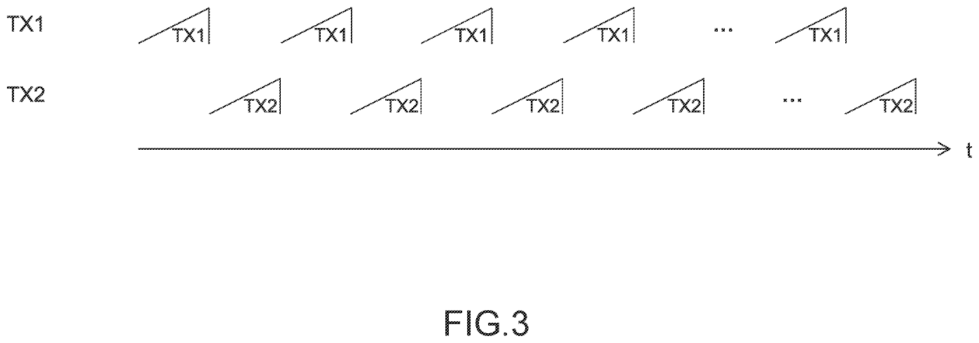

FIG. 3 schematically shows the concept of the TDM-MIMO.

In the case of realizing a MIMO radar, in general, time division multiplexing (TDM)-MIMO is often used as a method of transmitting chirp signals. In the TDM-MIMO, chirp signals to be transmitted from transmission antennas forming MIMO are transmitted in time division by the number of transmission antennas. For example, in MIMO with two transmission antennas, the two transmission antennas alternately transmit chirp signals TX1 and TX2. Here, there is a time lag between the transmission timings of the chirp signals TX1 and TX2 from the two transmission antennas. Therefore, in the case where an object has a speed (e.g., an oncoming vehicle), a phase shift occurs between a reception signal formed by the chirp signal TX1 from a first transmission antenna and a reception signal formed by the chirp signal TX2 from a second transmission antenna due to speed and time shifts.

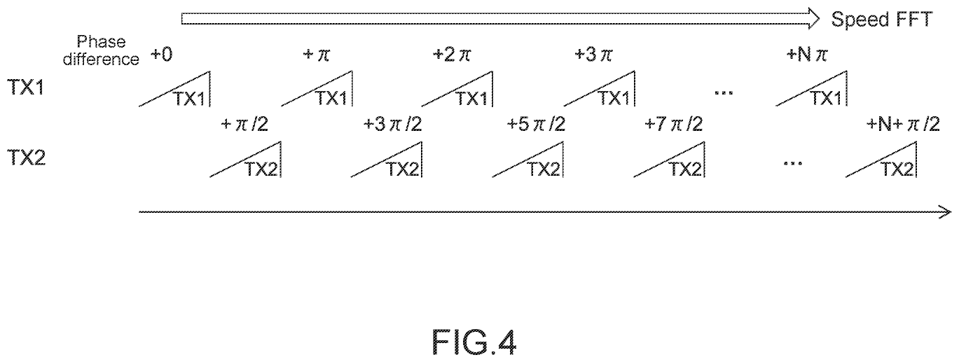

FIG. 4 schematically shows the concept of speed phase error correction of TDM-MIMO.

The speed of the object can be calculated by performing fast Fourier transform (FFT) (speed FFT) in the chirp direction on each of the chirp signals TX1 and TX2 after separating chirp signals multiplexed between a plurality of transmission antennas in the TDM-MIMO for each transmission antenna. Further, the speed FFT is capable of detecting the phase lead and lag due to the speed. In the example of FIG. 4, the phase advances by +π between a plurality of chirp signals TX1 from the first transmission antenna due to the speed. As shown in FIG. 4, if the phase difference between the plurality of chirp signals TX1 from the first transmission antenna due to the speed is +π, the phase of the chirp signal TX1 from the first transmission antenna and the phase of the chirp signal TX2 from the second transmission antenna are shifted by +π/2 (i.e., the phase error between TX1−TX2 is +π/2). For this reason, correcting the phase of the chirp signal TX2 from the second transmission antenna by −π/2 eliminates the phase difference between the chirp signal TX1 from the first transmission antenna and the chirp signal TX2 from the second transmission antenna. Even in the case where the object has a speed, the phase error between the chirp signal TX1 from the first transmission antenna and the chirp signal TX2 from the second transmission antenna can be corrected in this way.

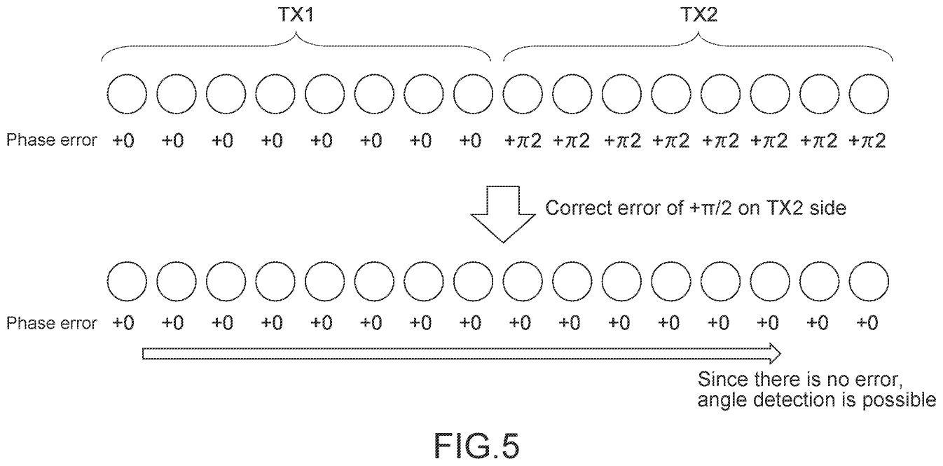

FIG. 5 schematically shows the concept of speed phase error correction of TDM-MIMO.

As described with reference to FIG. 4, when the phase difference between the plurality of chirp signals TX1 from the first transmission antenna is +π and the phase error between TX1-TX2 is +π/2, by correcting the phase of the chirp signal TX2 from the second transmission antenna by −π/2, the error between the chirp signals TX1 and TX2 is eliminated and angle detection is made possible.

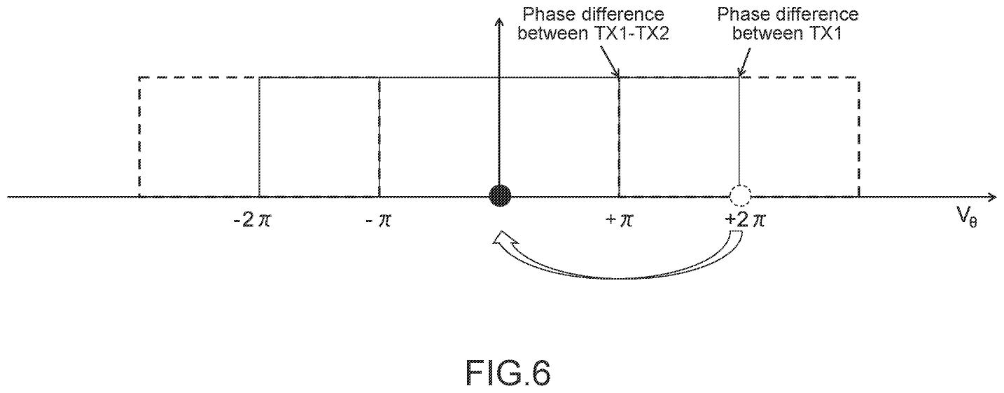

FIG. 6 schematically shows the concept of the limitation of speed phase correction due to speed ambiguity.

In accordance with the sampling theorem, the phase difference by the speed FFT can be detected only from −π to +π. However, in practice, the phase due to the speed exceeds +π in some cases. For example, in the case where the phase difference between chirps of the plurality of chirp signals TX1 from the first transmission antenna is +2π, the phase difference of +2π wraps to +0 when performing FFT.

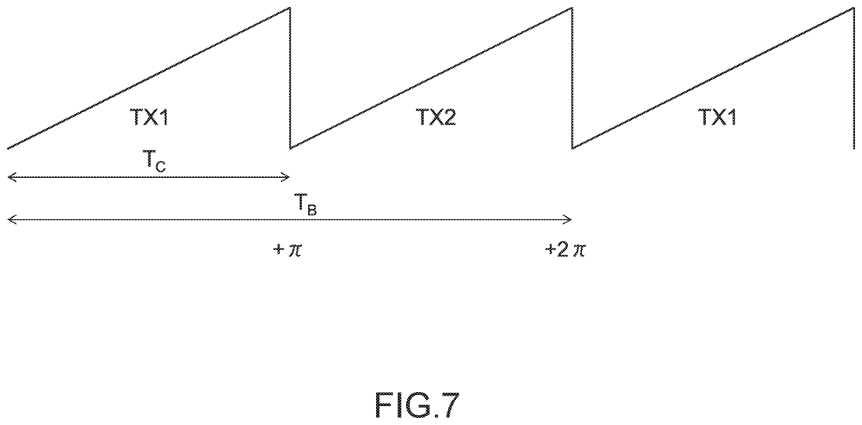

FIG. 7 schematically shows the concept of the limitation of speed phase correction due to speed ambiguity.

Typically, chirp signals are transmitted such that transmission timings of the chirp signals TX are equal to the burst intervals TB. The burst intervals TB are intervals between the plurality of chirp signals from the same antenna when separating the chirp signals multiplexed between the transmission antennas for each transmission antenna. That is, the chirp signal TX1 from the first transmission antenna and the chirp signal TX2 from the second transmission antenna are transmitted at equal intervals at the timings of 0 [μs] and TB×½ [μs], respectively. Assuming that the chirp intervals Tc are equal intervals, an angular velocity ω is obtained by the formula (1).

$$ω = φ / ( Ntx \cdot Tc ) = φ / TB [ rad . \text{/s} ] \qquad ( 1 )$$

As shown by the formula (1), in the case where the angular velocity ω=2π/TB, since the phase moves by +2π at each of the intervals TB, the phase moving at each of the chirp intervals Tc is +π.

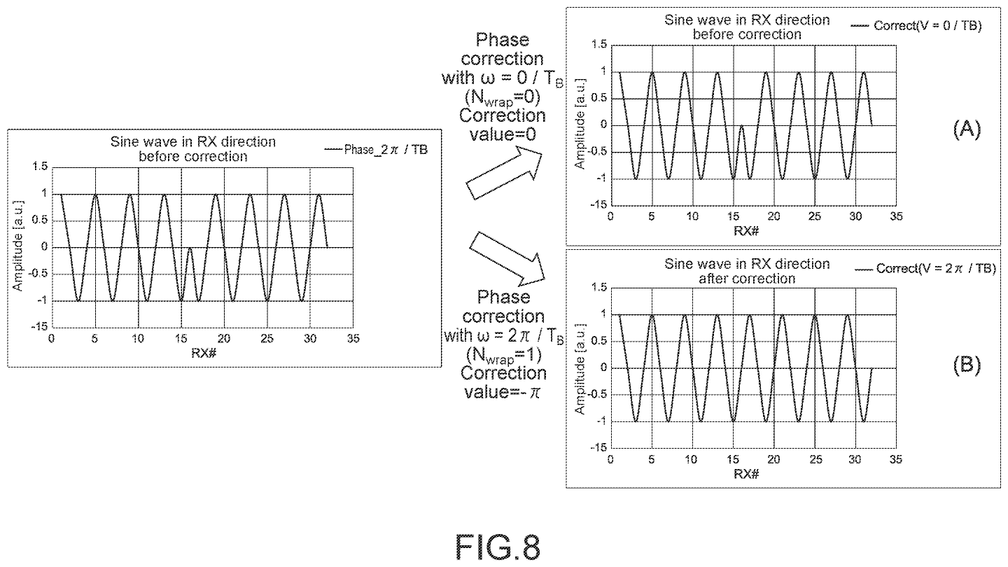

FIG. 8 shows correction of a phase difference due to speed ambiguity.

In the case where the angular velocity of the chirp signals TX1 and TX2 from the two transmission antennas in the A-MIMO satisfies the relationship of ω =2π/TB, the phase difference between the chirp signals TX1 and TX2 is n. However, the detected angular velocity satisfies the relationship of ω=0/TB. As shown in Part (A), in the case where the phase is corrected assuming that ω=0/TB and the number of speed wraps Nwrap=0, the correction value=0. As shown in Part (B), in the case where the phase is corrected assuming that ω=2π/TB and the number of speed wraps Nwrap=1, the correction value=−π. In the case of performing correction assuming that the number of speed wraps Nwrap=1, a sine wave with a continuous phase is obtained. At this time, in the arrival angle spectrum (AoA spectrum), the main lobe takes the largest value and the ratio between the main lobe and the side lobe becomes maximum.

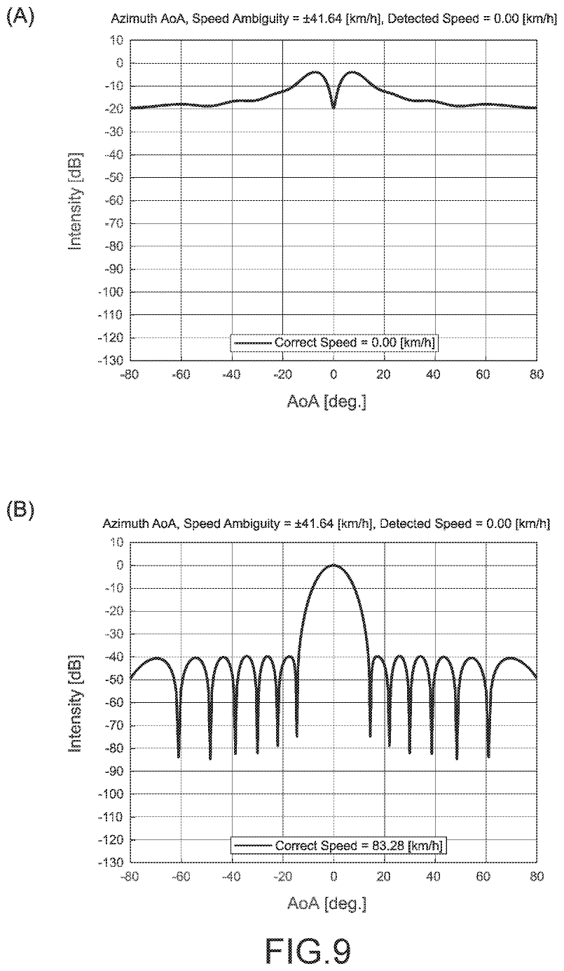

FIG. 9 shows correction of a phase difference due to speed ambiguity.

FFT is performed on the sine wave in the direction of the reception antenna after the correction shown in Parts (A) and (B) of FIG. 8. In both cases, a speed ambiguity Vambi=±41.64 [km/h], a detection speed by the speed FFT Vdet=0 [km/h], and an actual speed Vreal=83.28 [km/h]. The only difference is the number of speed wraps Nwrap=0 (A) and 1 (B). When FFT is performed on the sine wave in the direction of the reception antenna after the correction shown in Part (A) of FIG. 8, an erroneous spectrum is obtained as shown in Part (A) of FIG. 9. When FFT is performed on the sine wave in the direction of the reception antenna after the correction shown in Part (B) of FIG. 8, a correct spectrum is obtained as shown in Part (B) of FIG. 9.

As described above, the phase error due to the speed between the chirp signals TX1 and TX2 from the two transmission antennas in the TDM-MIMO can be detected and corrected by the result of the speed FFT. However, the above-mentioned phase correction is limited to a range of −π to +π in accordance with the sampling theorem. Even in the case where the phase wraps beyond the range of −π to +π, it is possible to expand the phase correction range to approximately −2π to +2π by performing correction on the assumption of the number of wraps. As a result, it is known that the speed range can be expanded.

However, in the technology for expanding the observable speed of chirp signals with equal intervals in the MIMO, the expandable speed range is limited. For example, in the case where two transmission antennas transmit chirp signals at equal intervals, there is a problem that the observable speed in the MIMO can expand only to approximately twice the speed before expansion.

Further, since the intervals for transmitting chirp signals are equal intervals, the phase difference of the speed and the phase difference of the height cannot be distinguished from each other because the phase difference of the speed and the phase difference of the height have the same linearity even in the case of trying to expand the speed by the technology described above in the vertical MIMO with equal intervals, and the correct speed cannot be determined. That is, there is a problem that the technology described above cannot be applied to the vertical MIMO with equal intervals.

In view of the circumstances as described above, it is desired to further widen the speed expansion range and make it applicable also to the vertical MIMO with equal intervals.

### 2. Difference Between Technology According to this Embodiment and Typical Technology

The speed range is generated by the ambiguity of the 2π period of the phase change. Therefore, when the observed speed is defined as Vmeas, the actual speed is one of hypothetical (candidates) Vhyp of the speed 2kVlim period corresponding to 2π. The hypothetical (candidates) Vhyp can be represented by the following formula.

$$Vhyp = 2 kVlim + Vmeas ( k = 0 , \pm 1 , \pm 2 , … ) .$$

In accordance with this formula, even if the range of Vmeas is narrow, the speed expansion can be realized if the number of speed wraps k (=Nwrap) can be widened (i.e., 2kVlim can be widened).

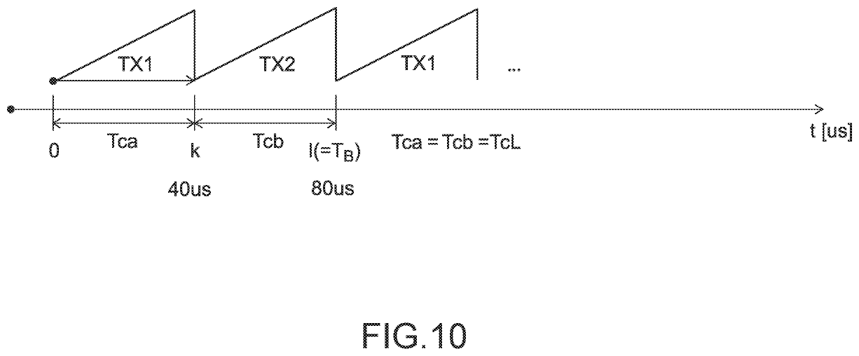

FIG. 10 schematically shows a case where transmission timings of chirp signals are equal intervals.

In this example, a transmission antenna array and a reception antenna array constitute a horizontal MIMO array (FIG. 1). A case of the chirp signals TX1 and TX2 from two transmission antennas will be generally described. Assumption is made that Tca=Tcb=k=40 μs (=TcL), TB being the burst interval=80 μs (=1), Tca being the interval from the first chirp signal TX1 to the second chirp signal TX2, Tcb being the interval from the second chirp signal TX2 to the next first chirp signal TX1. In this case, regrading the second chirp signal TX2, the formula (2) is established. Vdet is the detected speed (result of the speed FFT), and Vlim is the speed corresponding the upper limit of the speed (speed corresponding to a phase difference n in the burst interval TB). When the phase of Tx1 is zero, the phase of Tx2 is represented by the following formula.

$$Tx 2 = ( Vdet + 2 \times Vlim \times Nwrap ) \times ( k / 1 ) \times TB \qquad ( 2 )$$

Summarizing with Vlim×TB=n, the formula (3) is obtained.

$$Tx 2 = Vdet \times ( k / 1 ) \times TB + 2 \prod \times Nwrap \times ( k / 1 ) \qquad ( 3 )$$

In the formula (3), +2π×Nwrap×(k/1) is the 2π wrap term. At this time, wrapping occurs at a period in which Nwrap×(k/1) is an integer. Since k=40 μs and 1=80 μs (=TB), wrapping occurs at a period in which Nwrap×(40/80)=Nwrap×(½) is an integer. In the formula of Nwrap×(½)=n, the condition that both the left side and the right side are integers is when Nwrap is a multiple of two. At this time, the allowable wrap period is limited to two.

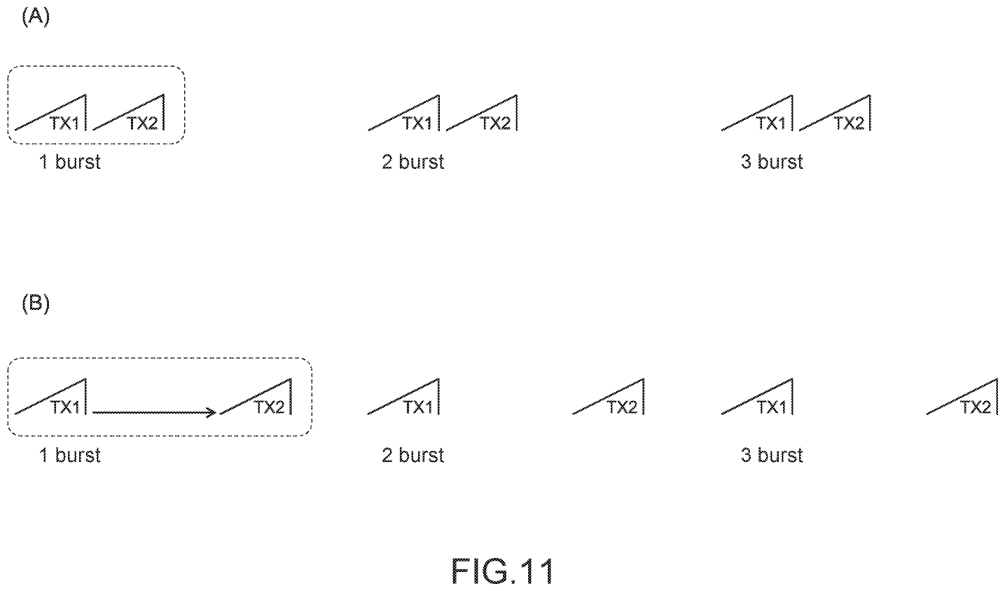

FIG. 11 schematically shows a difference between the technology according to this embodiment and a typical technology.

As shown in Part (A), in accordance with a typical technology, the burst intervals TB are equal intervals and the time difference between the transmission timings of the chirp signals TX1 and TX2 included in the respective bursts is also an equal interval in the horizontal MIMO array and TDM-MIMO (time division MIMO).

Meanwhile, as shown in Part (B), in accordance with this embodiment, the burst intervals TB are equal intervals and the transmission timings of the temporally continuous chirp signals TX1 and TX2 included in the respective bursts are unequal (i.e., the interval Tca from the chirp signal TX1 to the chirp signal TX2 and the interval Tcb from the chirp signal TX2 to the next chirp signal TX1 are unequal intervals) in the horizontal MIMO array and TDM-MIMO (time division MIMO). Since the burst intervals TB are equal intervals, a normal speed FFT can be executed.

### 3. This Embodiment

As shown in Part (B) of FIG. 11, in this embodiment, when the burst interval TB is a non-integer multiple with respect to the plurality of intervals Tc of the transmission timings of the chirp signals TX1 and TX2, the following formula is obtained.

$$TcL / TB > 1 / N$$

Here, TB is an interval between a plurality of chirp signals from the same transmission antenna when chirp signals multiplexed between transmission antennas are separated for each of the transmission antennas, the burst intervals are equal intervals, TcL is the longer one of the interval Tca from the two temporally continuous chirp signals TX1 to TX2 included in the respective bursts and the interval Tcb from the chirp signal TX2 to the next chirp signal TX1, and N is the number of transmission antennas separated as TX1 and TX2 for the multiplexed chirp signals.

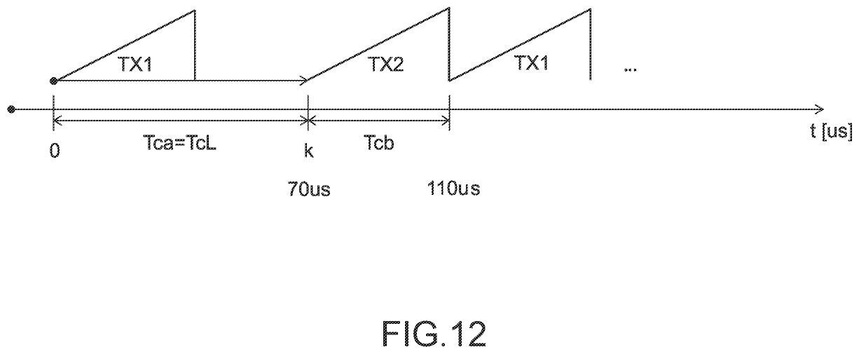

FIG. 12 schematically shows transmission timings of chirp signals according to this embodiment (horizontal MIMO array).

In this example, a transmission antenna array and a reception antenna array constitute a horizontal MIMO array (FIG. 1). As described with reference to FIG. 10, a case of the chirp signals TX1 and TX2 from two transmission antennas will be generally described. Assumption is made that the burst interval TB=110 μs (=1), the transmission timing of the first chirp signal TX1=0 μs, and a transmission timing k of the second chirp signal TX2=70 μs. In this case, regarding the second chirp signal TX2, the formulae (2) and (3) described above are established.

In the formula (3), +2π×Nwrap×(k/1) is the 2π wrap term. At this time, wrapping occurs at a period in which Nwrap×(k/1) is an integer. Since k=70 μs (=Tc2) and 1=110 μs (=TB), wrapping occurs at a period in which Nwrap×(70/110)=Nwarp×(7/11) is an integer. In the formula of Nwarp×(7/11)=n, since both Nwrap and n are integers, the condition that both the left side and the right side are integers is when Nwrap is a multiple of 11. At this time, the allowable wrap period is expanded to 11.

M speed candidates that can be taken in a speed width 2×Vmax×Nwrap obtained by Nwrap (Nwrap>N) and Vmax are calculated, Nwrap×(TcL/TB) (i.e., Nwrap×(k/1)) being an integer multiple. Here, Nwrap is the number of speed wraps. Further, M represents a natural number of one or greater.

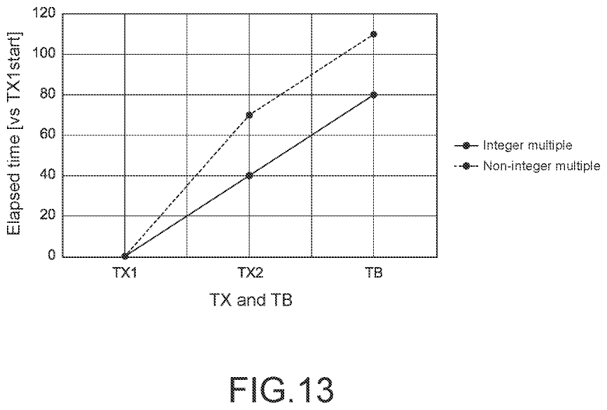

FIG. 13 shows transmission timings of phase differences between chirp signals for an integer multiple and a non-integer multiple.

As described above, in accordance with this embodiment, the transmission timings of the temporally continuous chirp signals TX1 and TX2 included in the respective bursts are unequal (i.e., the burst interval TB is a non-integer multiple of the time difference between the transmission timings of the chirp signals TX1 and TX2), thereby expanding the phase wrap range.

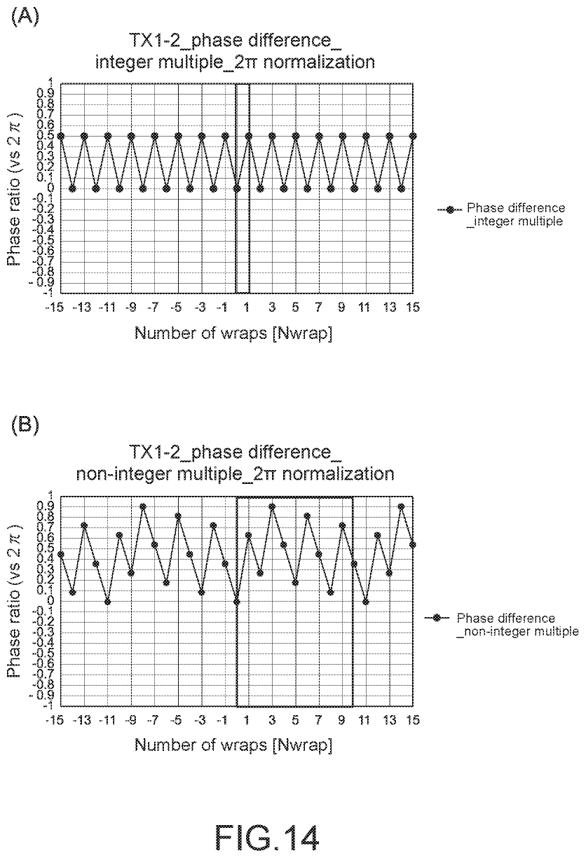

FIG. 14 shows a wrap period for each Nwrap when the angular velocity ω=Nwrap×(2n/TB).

As shown in Part (A), in accordance with a typical technology, assumption is made that the burst interval 1=80 μs (=TB) and the transmission timing k of the second chirp signal TX2=40 μs (=Tca=Tcb=TcL) (FIG. 10). The transmission timings of the chirp signals TX1 and TX2 included in the respective bursts are equal intervals (i.e., the burst interval TB is an integer multiple of the time difference Tca between the transmission timings of the chirp signals TX1 and TX2). When normalized by 2n, the wrap period is two times as shown by 0 to 1 in the frame.

On the other hand, as shown in Part (B), in accordance with this embodiment, assumption is made that the burst interval 1=110 μs (=TB) and the transmission timing k of the second chirp signal TX2=70 μs (=Tca=TcL) (FIG. 12). The transmission timings of the temporally continuous chirp signals TX1 and TX2 included in the respective bursts are unequal (i.e., the burst interval TB is a non-integer multiple of the time difference k between the transmission timings of the chirp signals TX1 and TX2). When normalized by 2n, the wrap period is 11 times as shown by 0 to 10 in the frame.

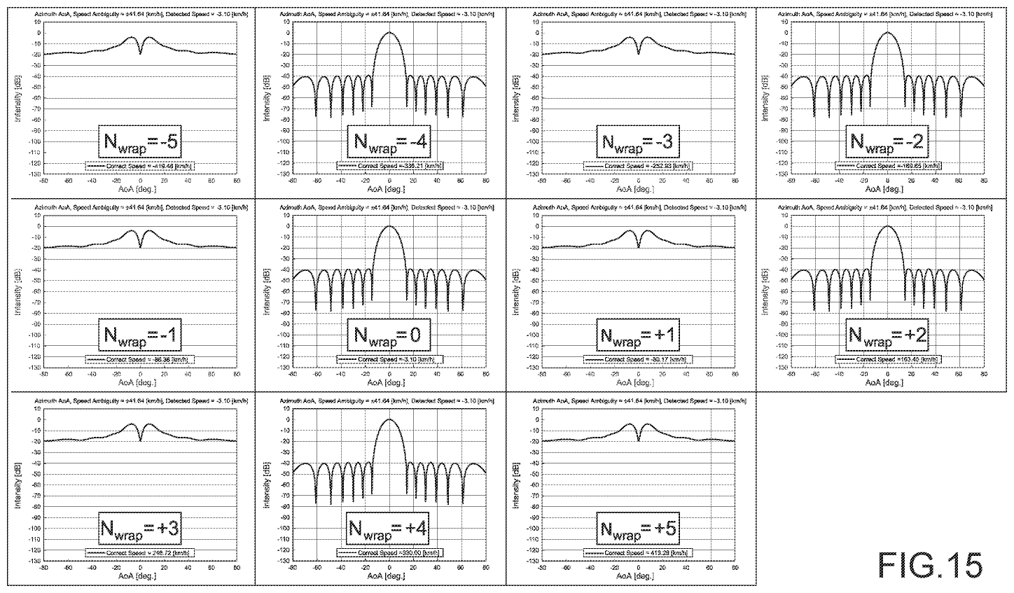

FIG. 15 shows arrival angle spectra of a plurality of speed candidates in a typical example (horizontal MIMO array).

In accordance with a typical technology, assumption is made that the burst interval 1=80 μs (=TB), the transmission timing k of the second chirp signal TX2=40 μs (=Tca=Tcb=TcL) (FIG. 10 and Part (A) of FIG. 14), Nwrap=±5, and Vreal=330 [km/h]. AoA is performed after performing speed phase correction on a plurality of speed candidates, and a speed candidate at which the dynamic range (difference between the maximum value and the minimum value) of the spectra is the largest is regarded as a true speed. As shown in FIG. 15, there are two types of speed candidates.

As shown in FIG. 15, when Nwrap=−5, −3, −1, +1, +3, and +5, the same spectrum is obtained. When Nwrap=−4, −2, 0, +2, and +4, the same spectrum is obtained. When comparing these spectra with each other, the spectrum with the maximum main lobe or the maximum ratio of the main lobe and the side lobe is the spectrum when Nwrap=−4, −2, 0, +2, or +4. The speed when Nwrap=−4 is −336.21 [km/h], the speed when Nwrap=−2 is −169.65 [km/h], the speed when Nwrap=0 is −3.10 [km/h], the speed when Nwrap=+2 is 163.45 [km/h], and the speed when Nwrap=+4 is 330.00 [km/h]. For this reason, which of these five speeds is the true speed cannot be specified.

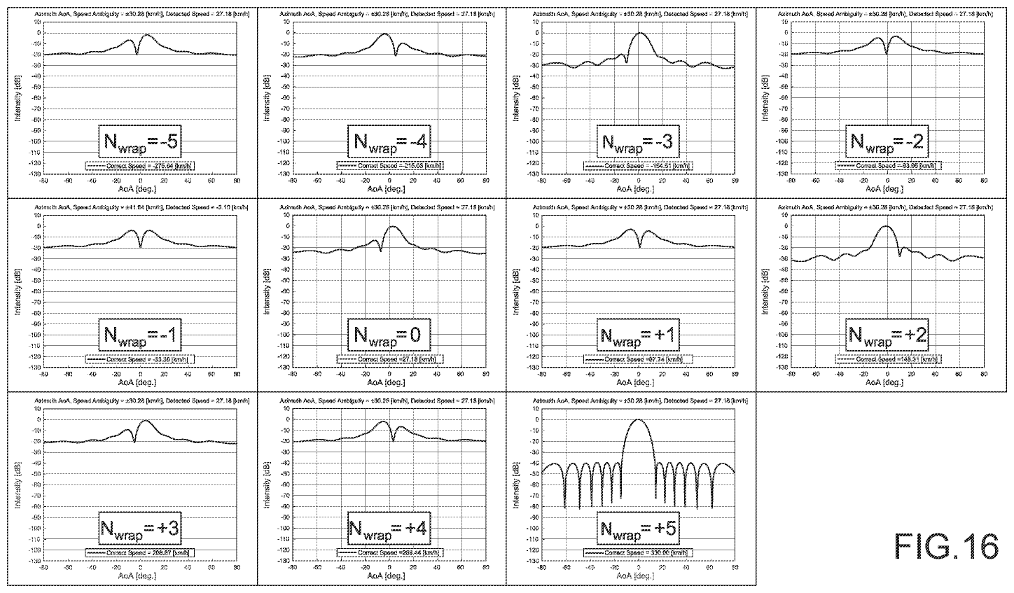

FIG. 16 shows arrival angle spectra of a plurality of speed candidates in this embodiment (horizontal MIMO array).

On the other hand, in accordance with this embodiment, assumption is made that the burst interval 1=110 μs (=TB), the interval k from the first chirp signal TX1 to the second chirp signal TX2=70 μs (=Tca=TcL) (FIG. 11 and Part (B) of FIG. 14), Nwrap=±5, and Vreal=330 [km/h]. AoA is performed after performing speed phase correction on a plurality of speed candidates, and a speed candidate with the maximum main lobe of the spectrum or the maximum ratio of the main lobe and the side lobe is regarded as a true speed. As shown in FIG. 16, there are 11 types of speed candidates.

Since the burst interval TB has extended from 80 μs to 110 μs, Vlim is reduced from ±41.64 [km/h] to ±30.28 [km/h]. However, the allowable number of wraps is expanded from 0.1 (2 times) to 0 to 10 (11 times) and Nwrap=−0.5, 0, and +0.5 is expanded to Nwrap=−5, −4, −3, −2, −1, 0, +1, +2, +3, +4, and +5. The effective observable speed is expanded from ±(41.64+2×41.64×0.5)=±83.28 [km/h] to ±(30.28+2×30.28×5)=±333.08 [km/h]. The arrival angle spectrum (AoA spectrum) corrected by the speed of 330 [km/h] has the maximum main lobe or the maximum ratio of the main lobe and the side lobe.

As shown in FIG. 16, when Nwarp=−5, −4, −3, −2, −1,0, +1, +2, +3, +4, and +5, the spectra are different from each other. When comparing these spectra with each other, the spectrum with the largest dynamic range (difference between the maximum value and the minimum value) is the spectrum when Nwrap=+5. The speed when Nwarp=+5 is 330.00 [km/h], and this can be specified as a true speed. In short, in accordance with this embodiment, only in the case of a correct speed, a correct arrival angle spectrum (AoA spectrum) with the maximum main lobe or the maximum ratio of the main lobe and the side lobe is output.

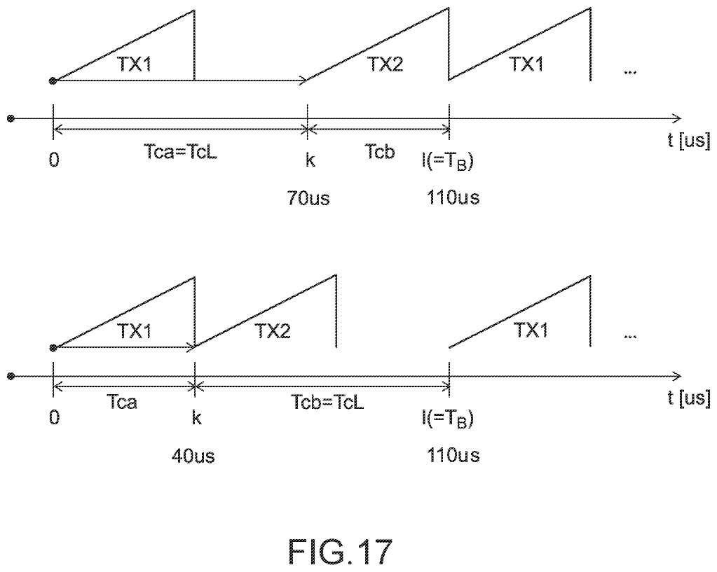

FIG. 17 shows an Example (time division) of this embodiment.

In accordance with this embodiment, if the longer one k (=TcL) (i.e., TcL/TB) of the interval from the chirp signals TX1 to TX2 with respect to the burst interval TB and the interval from TX2 to TX1 is larger than 1/N (N=2 in this example) (i.e., TcL/TB>1/N), it can be implemented. In both Parts (A) and (B), TcL/TB=7/11, and 7/11>½. In both Parts (A) and (B), the period of the number of wraps is 11.

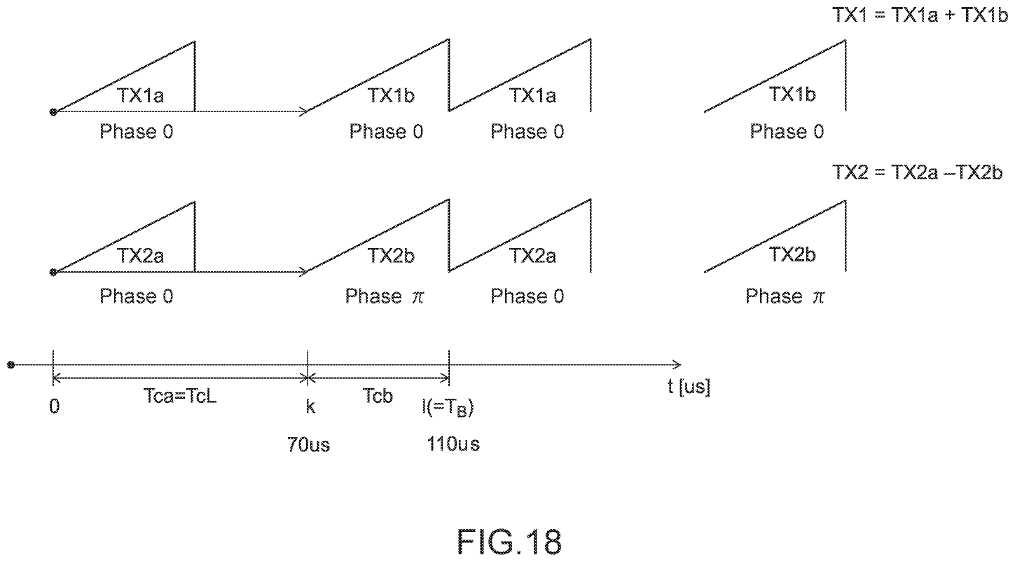

FIG. 18 shows another Example (phase division) of this embodiment.

A case where the chirp signals TX1 and TX2 are transmitted in time division has been described. Meanwhile, this embodiment is appliable also to a case where the chirp signals TX1 and TX2 are transmitted in phase division. When separating the chirp signals TX1 and TX2, TX1=TX1a+Tx1b and TX2=TX2a−Tx2b are synthesized after correcting the speed phase on the basis of a plurality of speed candidates (hypotheses), and then the true speed is determined by arrival angle estimation.

Also in the BPM-MIMO (phase division MIMO), the burst intervals TB are equal intervals and the transmission timings of the temporally continuous chirp signals TX1 and TX2 included in the respective bursts are unequal (i.e., the interval Tca from the chirp signal TX1 to the chirp signal TX2 and the interval Tcb from the chirp signal TX2 to the next chirp signal TX1 are unequal intervals), similarly to the TDM-MIMO (time division MIMO). Since the burst intervals TB are equal intervals, a normal speed FFT can be executed. When the burst interval TB is a non-integer multiple with respect to the plurality of intervals Tc of the transmission timings of the chirp signals TX1 and TX2, the following formula is obtained.

$$TcL / TB > 1 / N$$

Here, TB is an interval between a plurality of chirp signals from the same transmission antenna when chirp signals multiplexed between transmission antennas are separated for each of the transmission antennas, the burst intervals are equal intervals,
TcL is the longer one of the interval Tca from the two temporally continuous chirp signals TX1 to TX2 included in the respective bursts and the interval Tcb from the chirp signal TX2 to the next chirp signal TX1, and
N is the number of transmission antennas separated as TX1 and TX2 for the multiplexed chirp signals.

### 4. Modified Example

Variations of modified examples of this embodiment will be given. This embodiment is appliable to both the TDM-MIMO (time division MIMO) and BPM-MIMO (phase division MIMO). This embodiment is applicable to both cases where a transmission antenna array and a reception antenna array constitute a horizontal MIMO array and a vertical MIMO array. This embodiment is applicable to a two-dimensional MIMO. The arrival angle estimation can be performed by FFT (fast Fourier transformation) and DFT (discrete Fourier transformation). The arrival angle estimation can be performed by CAPON, MUSIC, ESPRIT, or compression sensing.

For example, as a modified example, a horizontal MIMO array, TDM-MIMO, and arrival angle estimation by FFT may be combined. As another modified example, a vertical MIMO array, TDM-MIMO, arrival angle estimation by CAPON, MUSIC, ESPRIT, or compression sensing may be combined. As another modified example, a horizontal MIMO array, BPM-MIMO, and arrival angle estimation by TDM-MIMO, CAPON, MUSIC, ESPRIT, compression sensing may be combined.

### 5. Brief Summary

The speed range in a typical equidistant MIMO is realistically limited to approximately ±100 km/h. However, in actual use, a minimum speed range of approximately ±200 km/h is required even on Japanese roads (assuming a scene where the own vehicle and an oncoming vehicle are travelling at 100 km/h on a highway). On the other hand, in accordance with this embodiment, it is possible to expand the observable speed to be wider than the speed range of the equidistant MIMO.

In a typical technology, since the intervals for transmitting chirp signals are equal intervals, the phase difference of the speed and the phase difference of the height cannot be distinguished from each other even in the case of trying to expand the speed by the technology described above in the vertical MIMO with equal intervals, and the correct speed cannot be determined. That is, the technology described above has a problem that it cannot be applied to the vertical MIMO with equal intervals. On the other hand, this embodiment is appliable also to the vertical MIMO with equal intervals because the intervals for transmitting chirp signals are unequal.

### 6. Example of Vertical MIMO

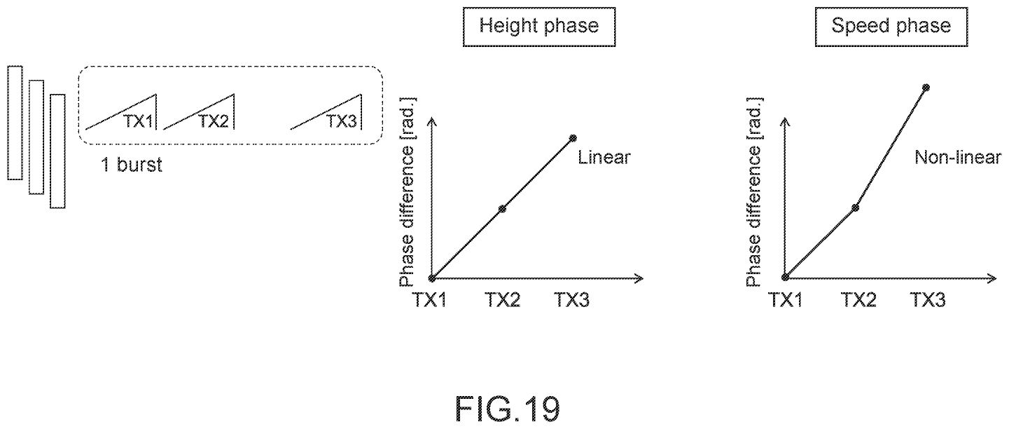

FIG. 19 schematically shows an Example of the concept of the vertical MIMO.

In a typical technology, since the intervals for transmitting chirp signals are equal intervals, the phase difference of the speed and the phase difference of the height cannot be distinguished from each other because the phase difference of the speed and the phase difference of the height have the same linearity even in the case of trying to expand the speed in the vertical MIMO with equal intervals, and the correct speed cannot be determined. That is, the technology described above has a problem that it cannot be applied to the vertical MIMO with equal intervals.

On the other hand, in accordance with this embodiment, if the transmission intervals between the chirp signals TX1 and TX2 are unequal intervals, the speed phase becomes non-linear with respect to the height phase. Therefore, only one speed can be calculated by performing non-linear correction when performing speed phase correction.

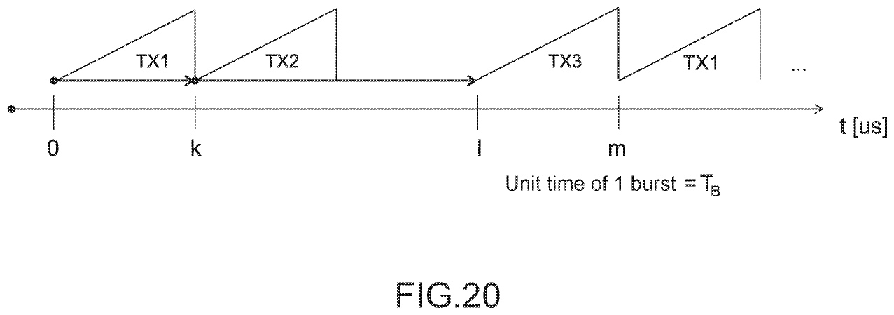

FIG. 20 schematically shows transmission timings of chirp signals according to this embodiment (vertical MIMO array).

In this example, a transmission antenna array and a reception antenna array constitute a vertical MIMO array (FIG. 2). A case of chirp signals TX1, TX2, and TX3 from three transmission antennas will be generally described. Assumption is made that a burst interval m (=TB), the transmission timing of the first chirp signal TX1=0 μs, the transmission timing k of the second chirp signal TX2 (=Tca), and a transmission timing l of the third chirp signal TX3 (=Tca+Tcb). In this case, the formula (4) for the second chirp signal TX2 and the formula (5) for the third chirp signal TX3 are established. Vdet is the detected speed (result of speed FFT) and Vlim is the upper limit of the speed (speed corresponding to the phase difference n)

$$Tx 2 = ( Vdet + 2 \times Vlim \times Nwrap ) \times ( k / m ) \times TB \qquad ( 4 )$$

$$Tx 3 = ( Vdet + 2 \times Vlim \times Nwrap ) \times ( l / m ) \times TB \qquad ( 5 )$$

$$k : l : m = 1 : ( l / k ) : ( m / k ) \\ However , ( l / k ) and ( m / k ) are integers \qquad ( 6 )$$

When the formula (6) is established, the formulae (7) and (8) are obtained, summarizing with (l/k)=α, (m/k)=β, and Vlim×TB=π.

$$Tx 2 = Vdet \times ( 1 / β ) \times TB + 2 \prod \times Nwrap \times ( 1 / β ) \qquad ( 7 )$$

$$Tx 3 = Vdet \times ( α / β ) \times TB + 2 \prod \times Nwrap \times ( α / β ) \qquad ( 8 )$$

At this time, wrapping occurs at a period of the formula (9).

$$Namb = β = ( m / k ) \qquad ( 9 )$$

Here, Namb is a period at which wrapping occurs.

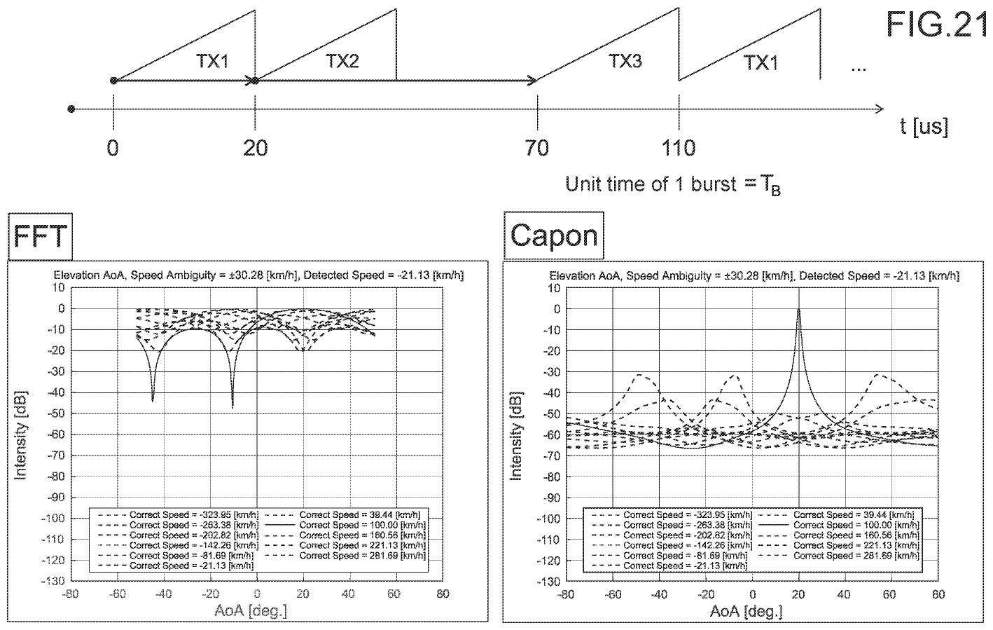

FIG. 21 shows arrival angle spectra of a plurality of speed candidates in this embodiment (vertical MIMO array).

In accordance with this embodiment, assumption is made that the burst interval m=110 μs (=TB), the transmission timing of the first chirp signal TX1=0 μs, the transmission timing k of the second chirp signal TX2=20 μs, and the transmission timing k of the third chirp signal TX3=70 μs. AoA is performed after performing speed phase correction (FFT or Capon) on a plurality of speed candidates, and a speed candidate with the maximum main lobe of the spectrum or the maximum ratio of the main lobe and the side lobe is regarded as a true speed. Since the chirp intervals are unequal intervals, an arrival angle estimation spectrum with the maximum main lobe or the maximum ratio of the main lobe and the side lobe is obtained only at the true speed for the plurality of speed candidates (hypotheses).

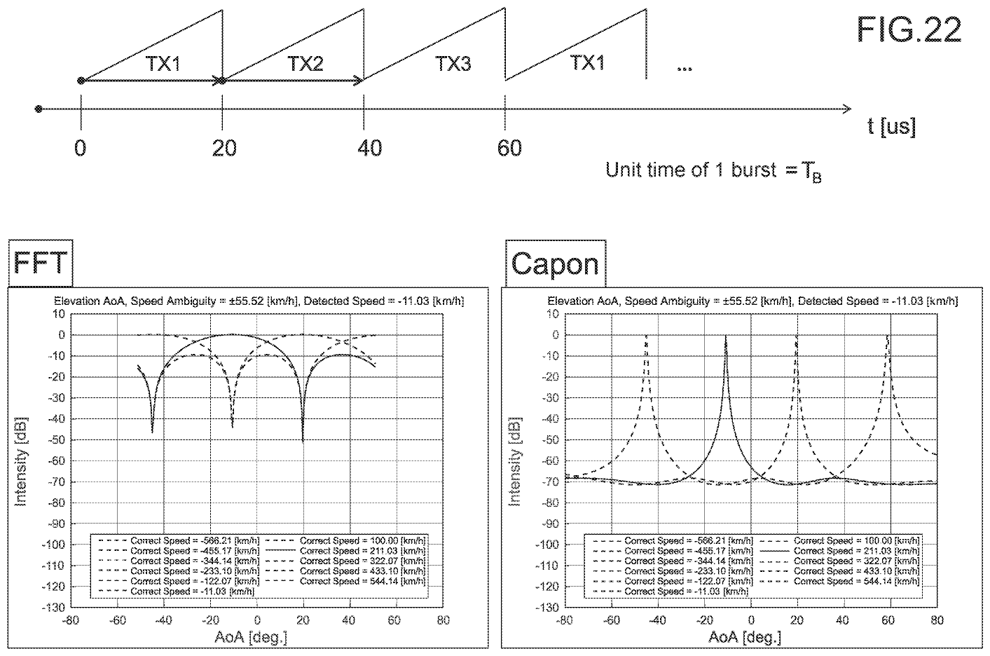

FIG. 22 shows arrival angle spectra of a plurality of speed candidates in a typical example (vertical MIMO array).

On the other hand, in accordance with a typical technology, assumption is made that the burst interval m=60 μs (=TB), the transmission timing of the first chirp signal TX1=0 μs, the transmission timing k of the second chirp signal TX2=20 μs, and the transmission timing k of the third chirp signal TX3=40 μs. AoA is performed after performing speed phase correction (FFT or Capon) on a plurality of speed candidates, and a speed candidate with the maximum main lobe of the spectrum or the maximum ratio of the main lobe and the side lobe is regarded as a true speed. Since the chirp intervals are unequal intervals, an arrival angle estimation spectrum with the maximum main lobe or the maximum ratio of the main lobe and the side lobe is obtained for the plurality of speed candidates (hypotheses). For this reason, a true speed cannot be specified.

### 7. Configuration of this Embodiment

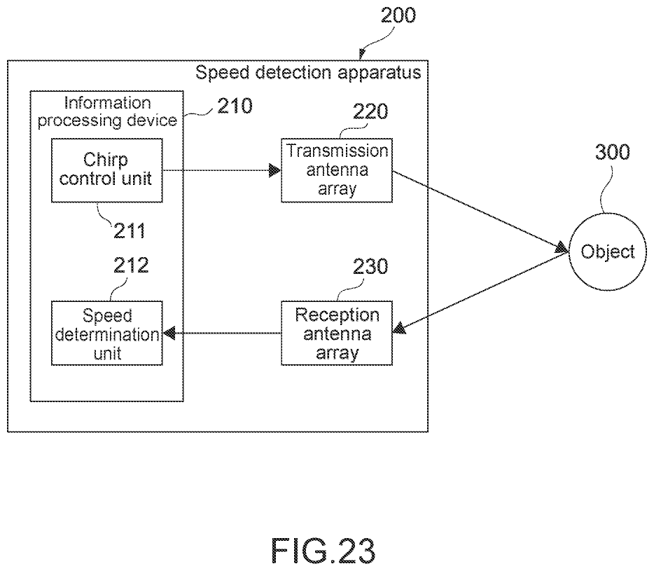

FIG. 23 is a block diagram showing a configuration of a speed detection apparatus according to this embodiment.

A speed detection apparatus 200 includes an information processing device 210, a transmission antenna array 220, and a reception antenna array 230. The information processing device 210 operates as a chirp control unit 211 and a speed determination unit 212 when a CPU loads an information processing program stored in a ROM into a RAM and executes the program.

The transmission antenna array 220 and the reception antenna array 230 constitute a horizontal MIMO array or a vertical MIMO array. The transmission antenna array 220 includes a plurality of transmission antennas, each of which transmits a plurality of chirp signals. The reception antenna array 230 includes a plurality of reception antennas that receives a plurality of chirp signals reflected by the object 300.

The chirp control unit 211 causes each of the plurality of transmission antennas to transmit the plurality of chirp signals such that burst intervals TB of a burst that is a group unit of the plurality of chirp signals transmitted from each of the plurality of transmission antennas are equal intervals and transmission timings of the temporally continuous chirp signals included in the respective bursts are unequal.

Specifically, the chirp control unit 211 causes each of the plurality of transmission antennas to transmit the plurality of chirp signals such that TcL/TB>1/N is established. Here, TB is the burst interval of a burst that is a group unit of the plurality of chirp signals transmitted from each of the plurality of transmission antennas, TcL is the longest interval of the intervala Tca from the plurality of temporally continuous chirp signals TX1 to TX2 included in the respective bursts, the interval Tcb from the chirp signal TX2 to the next chirp signal TX3, . . . , an interval TcN from TXN−1 to TXN, and N is the number of transmission antennas separated as TX1, TX2, TX3, . . . , and TXN for the multiplexed chirp signals.

The chirp control unit 211 causes each of the plurality of transmission antennas to transmit the plurality of chirp signals in time division. Alternatively, the chirp control unit 211 causes each of the plurality of transmission antennas to transmit the plurality of chirp signals in phase division.

The speed determination unit 212 calculates, on the basis of the plurality of reflected chirp signals received by the plurality of reception antennas, M speed candidates faster than the maximum speed Vmax obtained from the burst intervals TB, acquires M arrival angle spectra by performing phase error correction and arrival angle estimation on the M speed candidates, and determines a true speed by processing the M arrival angle spectra.

The speed determination unit 212 performs arrival angle estimation by fast Fourier transform (FFT) or discrete Fourier transform (DFT). The speed determination unit 212 performs arrival angle estimation by CAPON, MUSIC, ESPRIT, or compression sensing. The speed determination unit 212 calculates a plurality of speed candidates that can be taken in a speed width 2×Vmax×Nwrap obtained by Nwrap (Nwrap>N) and Vmax, Nwrap×(Tc2/TB) being an integer multiple, Nwrap being the number of speed wraps.

The speed detection apparatus 200 according to this embodiment or the information processing device 210 excluding the transmission antenna array 220 and the reception antenna array 230 can be applied to a vehicle control system 11.

### 8. Configuration of Vehicle

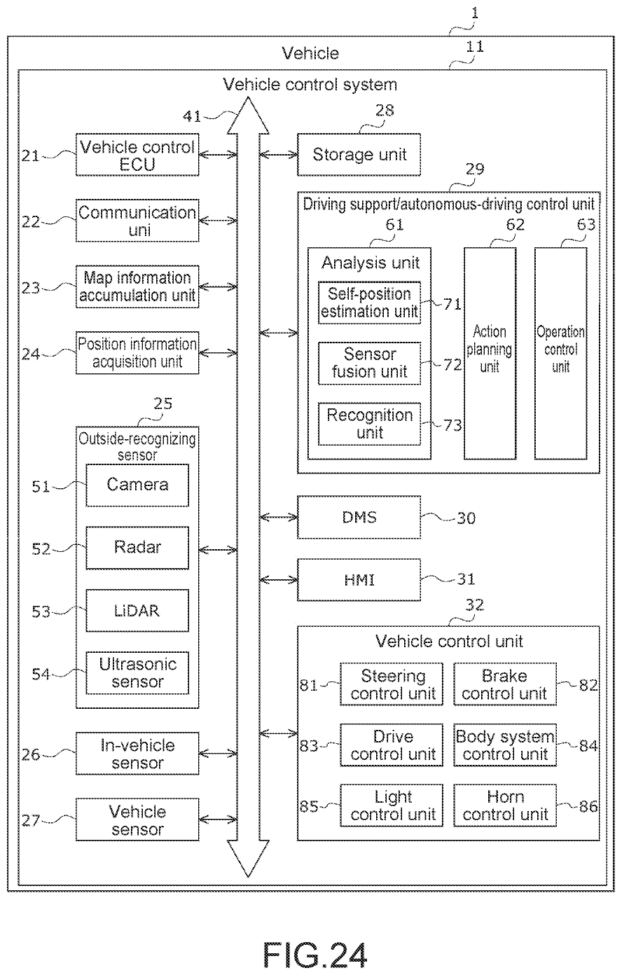

FIG. 24 is a block diagram showing a configuration example of the vehicle control system 11 that is an example of a moving device control system to which the present technology is applied.

The vehicle control system 11 is provided in a vehicle 1 and performs processing relating to driving support and automated driving of the vehicle 1.

The vehicle control system 11 includes a vehicle control ECU (Electronic Control Unit) 21, a communication unit 22, a map information accumulation unit 23, a position information acquisition unit 24, an outside-recognizing sensor 25, an in-vehicle sensor 26, a vehicle sensor 27, a storage unit 28, a driving support/automated-driving control unit 29, a DMS (Driver Monitoring System) 30, an HMI (Human Machine Interface) 31, and a vehicle control unit 32.

The vehicle control ECU (Electronic Control Unit) 21, the communication unit 22, the map information accumulation unit 23, the position information acquisition unit 24, the outside-recognizing sensor 25, the in-vehicle sensor 26, the vehicle sensor 27, the storage unit 28, the driving support/automated-driving control unit 29, the driver monitoring system (DMS) 30, the human machine interface (HMI) 31, and the vehicle control unit 32 are communicably connected to each other via a communication network 41. The communication network 41 includes an in-vehicle communication network, a bus, or the like conforming to the digital bidirectional communication standard such as a CAN (Controller Area Network), a LIN (Local Interconnect Network), a LAN (Local Area Network), FlexRay (registered trademark), and Ethernet (registered trademark). The communication network 41 may be used properly depending on the type of data to be transmitted. For example, CAN may be applied for data relating to vehicle control and Ethernet may be applied for large-capacity data. Note that the respective units of the vehicle control system 11 are directly connected to each other using wireless communication assuming relatively short-distance communication, such as near field communication (NFC) and Bluetooth (registered trademark) without the communication network 41 in some cases.

Note that hereinafter, in the case where the respective units of the vehicle control system 11 communicate with each other via the communication network 41, description of the communication network 41 will be omitted. For example, in the case where the vehicle control ECU 21 and the communication unit 22 communicate with each other via the communication network 41, it is described that the vehicle control ECU 21 and the communication unit 22 are communicated with each other.

The vehicle control ECU 21 includes various processors such as a CPU (Central Processing Unit) and an MPU (Micro Processing Unit). The vehicle control ECU 21 controls the functions of the entire vehicle control system 11 or part thereof.

The communication unit 22 communicates with various devices inside and outside the vehicle, another vehicle, a server, a base station, and the like, and transmits/receives various types of data. At this time, the communication unit 22 is capable of performing communication using a plurality of communication methods.

The communication with the outside, which can be executed by the communication unit 22, will be schematically described. The communication unit 22 communicates with a server present on an external network (hereinafter, referred to as the external server) or the like via a base station or an access point by a wireless communication method such as 5G (5th generation mobile communication system), LTE (Long Term Evolution), and DSRC (Dedicated Short Range Communications). The external network with which the communication unit 22 communicates is, for example, the Internet, a cloud network, or a network unique to a business operator. The communication method of the communication performed by the communication unit 22 with the external network is not particularly limited as long as it is a wireless communication method capable of performing digital bidirectional communication at a predetermined communication speed or more and a predetermined distance or more.

Further, for example, the communication unit 22 is capable of communicating with a terminal present in the vicinity of the own vehicle using a P2P (Peer To Peer) technology. The terminal present in the vicinity of the own vehicle is, for example, a terminal worn by a moving object that moves at a relatively low speed such as a pedestrian and a bicycle, a terminal installed at a fixed position in a store or the like, or an MTC (Machine Type Communication) terminal. Further, the communication unit 22 is capable of performing V2X communication. The V2X communication is communication between the own vehicle and others such as vehicle-to-vehicle communication with another vehicle, vehicle-to-infrastructure communication with a roadside device or the like, vehicle-to-home communication with a home, and vehicle-to-pedestrian communication with a terminal owned by a pedestrian.

The communication unit 22 is capable of receiving, from the outside, a program for updating software that controls the operation of the vehicle control system 11, for example (Over The Air). The communication unit 22 is capable of further receiving, from the outside, map information, traffic information, information around the vehicle 1, and the like. Further, for example, the communication unit 22 is capable of transmitting, to the outside, information relating to the vehicle 1 or information around the vehicle 1. Examples of the information relating to the vehicle 1 transmitted by the communication unit 22 to the outside include data indicating the state of the vehicle 1 and the recognition result by a recognition unit 73. Further, for example, the communication unit 22 performs communication corresponding to the vehicle emergency call system such as ecall.

For example, the communication unit 22 receives electromagnetic waves transmitted by vehicle information and communication system (VICS) (registered trademark) including a radio wave beacon, an optical beacon, and FM multiplex broadcasting.

The in-vehicle communication that can be executed by the communication unit 22 will be schematically described. The communication unit 22 is capable of communicating with each device in the vehicle using, for example, wireless communication. The communication unit 22 is capable of performing wireless communication with the device in the vehicle by a communication method capable of performing digital bidirectional communication at a predetermined communication speed or more by wireless communication such as a wireless LAN, Bluetooth, NFC, and WUSB (Wireless USB). The present disclosure is not limited thereto, and the communication unit 22 is capable of communicating with each device in the vehicle using wired communication. For example, the communication unit 22 is capable of communicating with each device in the vehicle by wired communication via a cable connected to a connection terminal (not shown). The communication unit 22 is capable of communicating with each device in the vehicle by a communication method capable of performing digital bidirectional communication at a predetermined communication speed or more by wired communication such as USB (Universal Serial Bus), HDMI (registered trademark) (High-Definition Multimedia Interface), and MHL (Mobile High-definition Link).

Here, the device in the vehicle represents, for example, a device that is not connected to the communication network 41 in the vehicle. As the device in the vehicle, for example, a mobile device or wearable device owned by a passenger such as a driver, an information device that is brought into the vehicle and temporarily installed, and the like are assumed.

The map information accumulation unit 23 accumulates one or both of the map acquired from the outside and the map created by the vehicle 1. For example, the map information accumulation unit 23 accumulates a three-dimensional high-precision map, a global map that has precision lower than that of the high-precision map but covers a wider area, and the like.

The high-precision map is, for example, a dynamic map, a point cloud map, or a vector map. The dynamic map is, for example, a map including four layers of dynamic information, quasi-dynamic information, quasi-static information, and static information, and is provided from the external server or the like to the vehicle 1. The point cloud map is a map including point clouds (point cloud data). The vector map is, for example, a map conforming to ADAS (Advanced Driver Assistance System) or AD (Autonomous Driving), in which traffic information such as lanes and positions of traffic lights is associated with a point cloud map.

The point cloud map and the vector map may be provided from, for example, the external server, or may be created by the vehicle 1 on the basis of the sensing result by a camera 51, a radar 52, a LiDAR 53, and the like as a map for matching with a local map described below and accumulated in the map information accumulation unit 23. Further, in the case where a high-precision map is provided from the external server or the like, for example, map data of several hundred meters square relating to the planned route through which the vehicle 1 will travel is acquired from the external server or the like in order to reduce the communication capacity.

The position information acquisition unit 24 receives a GNSS signal from a GNSS (Global Navigation Satellite System) satellite to acquire position information of the vehicle 1. The received position information is supplied to the driving support/automated-driving control unit 29. Note that the position information acquisition unit 24 does not necessary use the method using a GNSS signal and may acquire position information using a beacon, for example.

The outside-recognizing sensor 25 includes various sensors used for recognizing the external situation of the vehicle 1 and supplies sensor data from each sensor to the respective units of the vehicle control system 11. The type and number of the sensors included in the outside-recognizing sensor 25 are arbitrary.

For example, the outside-recognizing sensor 25 includes the camera 51, the radar 52, the LiDAR (Light Detection and Ranging, Laser Imaging Detection and Ranging) 53, and an ultrasonic sensor 54. The present disclosure is not limited thereto, and the outside-recognizing sensor 25 may include one or more of sensors of the camera 51, the radar 52, the LiDAR 53, and the ultrasonic sensor 54. The numbers of cameras 51, radars 52, LiDARs 53, and ultrasonic sensors 54 are not particularly limited as long as they can be practically installed in the vehicle 1. Further, the type of the sensor included in the outside-recognizing sensor 25 is not limited to this example, and the outside-recognizing sensor 25 may include other types of sensors. An example of the sensing region of each sensor included in the outside-recognizing sensor 25 will be described below.

Note that the imaging method of the camera 51 is not particularly limited. For example, as the camera 51, a camera of various imaging methods capable of performing distance measurement, such as a ToF (Time Of Flight) camera, a stereo camera, a monocular camera, and an infrared camera, can be applied as necessary. The present disclosure is not limited thereto, and the camera 51 does not necessarily perform distance measurement and may be for simply acquiring a captured image.

Further, for example, the outside-recognizing sensor 25 may include an environment sensor for detecting the environment for the vehicle 1. The environment sensor is a sensor for detecting the environment including weather, climate, and brightness, and may include various sensors such as a raindrop sensor, a fog sensor, a sunshine sensor, a snow sensor, and an illuminance sensor.

Further, for example, the outside-recognizing sensor 25 includes a microphone used for, for example, detecting sound around the vehicle 1 and the position of the sound source.

The in-vehicle sensor 26 includes various sensors for detecting in-vehicle information, and supplies sensor data from each sensor to the respective units of the vehicle control system 11. The type and number of various sensors included in the in-vehicle sensor 26 are not particularly limited as long as they can be practically installed in the vehicle 1.

For example, the in-vehicle sensor 26 may include one or more sensors of a camera, a radar, a seating sensor, a steering wheel sensor, a microphone, and a biosensor. As the camera included in the in-vehicle sensor 26, for example, a camera of various imaging methods capable of performing distance measurement, such as a ToF camera, a stereo camera, a monocular camera, and an infrared camera, can be used. The present disclosure is not limited thereto, and the camera included in the in-vehicle sensor 26 does not necessarily perform distance measurement and may be for simply acquiring a captured image. The biosensor included in the in-vehicle sensor 26 is provided on, for example, a seat or a steering wheel, and detects various types of biometric information of a passenger such as the driver.

The vehicle sensor 27 includes various sensors for detecting the state of the vehicle 1 and supplies sensor data from each sensor to the respective units of the vehicle control system 11. The type and number of various sensors included in the vehicle sensor 27 are not particularly limited as long as they can be practically installed in the vehicle 1.

For example, the vehicle sensor 27 includes a speed sensor, an acceleration sensor, an angular velocity sensor (gyro sensor), and an inertial measurement unit (IMU) that integrates them. For example, the vehicle sensor 27 includes a steering angle sensor that detects the steering angle of a steering wheel, a yaw rate sensor, an accelerator sensor that detects the amount of operation of an accelerator pedal, and a brake sensor that detects the amount of operation of a brake pedal. For example, the vehicle sensor 27 includes a rotation sensor that detects the RPM of an engine or a motor, a pneumatic sensor that detects a tire pressure, a slip rate sensor that detects the slip rate of a tire, and a wheel speed sensor that detects the rotation speed of a wheel. For example, the vehicle sensor 27 includes a battery sensor that detects the remaining amount and temperature of a battery and an impact sensor that detects the impact from the outside.

The storage unit 28 includes at least one of a non-volatile storage medium or a volatile storage medium, and stores data and a program. The storage unit 28 is used as, for example, an EEPROM (Electrically Erasable Programmable Read Only Memory) and a RAM (Random Access Memory). As a storage medium, a magnetic storage device such as an HDD (Hard Disc Drive), a semiconductor storage device, an optical storage device, and a magneto-optical storage device are applicable. The storage unit 28 stores various programs and data used by the respective units of the vehicle control system 11. For example, the storage unit 28 includes an EDR (Event Data Recorder) and a DSSAD (Data Storage System for Automated Driving), and stores information regarding the vehicle 1 before and after an event such as an accident and information acquired by the in-vehicle sensor 26.

The driving support/automated-driving control unit 29 controls driving support and automated driving of the vehicle 1. For example, the driving support/automated-driving control unit 29 includes an analysis unit 61, an action planning unit 62, and an operation control unit 63.

The analysis unit 61 performs processing of analyzing the vehicle 1 and the surrounding situation. The analysis unit 61 includes a self-position estimation unit 71, a sensor fusion unit 72, and the recognition unit 73.

The self-position estimation unit 71 estimates the self-position of the vehicle 1 on the basis of the sensor data from the outside-recognizing sensor 25 and the high-precision map accumulated in the map information accumulation unit 23. For example, the self-position estimation unit 71 generates a local map on the basis of the sensor data from the outside-recognizing sensor 25, and matches the local map with the high-precision map to estimate the self-position of the vehicle 1. The position of the vehicle 1 is based on, for example, the center of the rear wheel-to-axle.

The local map is, for example, a three-dimensional high-precision map or an occupancy grid map created using a technology such as SLAM (Simultaneous Localization and Mapping). The three-dimensional high-precision map is, for example, the above-mentioned point cloud map. The occupancy grid map is a map that is obtained by dividing a three-dimensional or two-dimensional space around the vehicle 1 into grids of a predetermined size and shows the occupied state of an object in units of grids. The occupied state of an object is shown by, for example, the presence or absence of the object or the probability of presence. The local map is also used by, for example, the recognition unit 73 for detecting and recognizing the external situation of the vehicle 1.

Note that the self-position estimation unit 71 may estimate the self-position of the vehicle 1 on the basis of the position information acquired by the position information acquisition unit 24 and the sensor data from the vehicle sensor 27.

The sensor fusion unit 72 performs sensor fusion processing of acquiring new information by combining a plurality of different types of sensor data (e.g., the image data supplied from the camera 51 and the sensor data supplied from the radar 52). Examples of the method of combining different types of sensor data include integration, fusion, and association.

The recognition unit 73 executes detection processing of detecting the external situation of the vehicle 1 and recognition processing of recognizing the external situation of the vehicle 1.

For example, the recognition unit 73 performs the detection processing and recognition processing of the external situation of the vehicle 1 on the basis of information from the outside-recognizing sensor 25, information from the self-position estimation unit 71, information from the sensor fusion unit 72, or the like.

Specifically, for example, the recognition unit 73 performs detection processing and recognition processing of an object around the vehicle 1. The detection processing of an object is, for example, processing of detecting the presence or absence of an object, or the size, shape, position, and movement of the object. The recognition processing of an object is, for example, processing of recognizing the attribute of an object such as a type or identifying a specific object. However, the detection processing and the recognition processing are not necessarily clearly separated from each other and overlap with each other in some cases.

For example, the recognition unit 73 detects an object around the vehicle 1 by performing clustering for classifying point clouds based on the sensor data acquired by the radar 52, the LiDAR 53, or the like into each block of point clouds. As a result, the presence or absence of an object around the vehicle 1, and the size, shape, and position of the object are detected.

For example, the recognition unit 73 detects the movement of an object around the vehicle 1 by performing tracking for following the movement of the block of point clouds classified by the clustering. As a result, the speed and the traveling direction (movement vector) of the object around the vehicle 1 are detected.

For example, the recognition unit 73 detects or recognizes, on the basis of the image data supplied from the camera 51, a vehicle, a person, a bicycle, an obstacle, a structure, a road, a traffic light, a traffic sign, a road sign, and the like. Further, the type of an object around the vehicle 1 may be recognized by performing recognition processing such as semantic segmentation.

For example, the recognition unit 73 is capable of performing processing of recognizing traffic rules around the vehicle 1 on the basis of the map accumulated in the map information accumulation unit 23, the estimation result of the self-position by the self-position estimation unit 71, and the recognition result of an object around the vehicle 1 by the recognition unit 73. The recognition unit 73 is capable of recognizing, by this processing, the position and state of the traffic light, the content of the traffic sign and road sign, the content of the traffic regulation, the lane in which the vehicle is capable of travelling, and the like.

For example, the recognition unit 73 is capable of performing recognition processing of the surrounding environment of the vehicle 1. As the surrounding environment to be recognized by the recognition unit 73, the weather, temperature, humidity, brightness, the state of a road surface, and the like are assumed.

The action planning unit 62 creates an action plan of the vehicle 1. For example, the action planning unit 62 creates an action plan by performing processing of route planning and route tracking.

Note that the route planning (Global path planning) is processing of planning a rough route from a start to a goal. This route planning includes also processing of trajectory generation (Local path planning) called trajectory planning, the vehicle 1 being capable of safely and smoothly traveling through the trajectory in the vicinity of the vehicle 1 in the route planned in the route planning considering the kinetic characteristics of the vehicle 1.

The route tracking is processing of planning an operation for safely and accurately traveling on a route planned by the route planning within a planned time. The action planning unit 62 is capable of, for example, calculating the target speed and the target angular velocity of the vehicle 1 on the basis of the result of the route tracking processing.

The operation control unit 63 controls the operation of the vehicle 1 in order to realize the action plan created by the action planning unit 62.

For example, the operation control unit 63 controls a steering control unit 81, a brake control unit 82, and a drive control unit 83 included in the vehicle control unit 32 described below to perform acceleration/deceleration control and direction control such that the vehicle 1 travels through the trajectory calculated by the trajectory planning. For example, the operation control unit 63 performs coordination control for the purpose of realizing the functions of ADAS, such as collision avoidance, impact mitigation, follow-up driving, vehicle-speed maintaining driving, collision warning of the own vehicle, and lane deviation warning of the own vehicle. For example, the operation control unit 63 performs coordination control for the purpose of automated driving for automatedly traveling without an operation of the driver.

The DMS 30 performs authentication processing of the driver, recognition processing of the state of the driver, and the like, on the basis of the sensor data from the in-vehicle sensor 26, the input data input to the HMI 31 described below, and the like. As the state of the driver to be recognized, for example, the physical condition, the degree of alertness, the degree of concentration, the degree of fatigue, the gaze direction, the degree of drunkenness, the driving operation, and the posture are assumed.

Note that the DMS 30 may perform the authentication processing of a passenger other than the driver and the recognition processing of the state of the passenger. Further, for example, the DMS 30 may perform the recognition processing of the situation in the vehicle on the basis of the sensor data from the in-vehicle sensor 26. As the situation in the vehicle to be recognized, for example, temperature, humidity, brightness, odor, and the like are assumed.

The HMI 31 inputs various types of data and instructions, and presents various types of data to the driver and the like.

The input of data by the HMI 31 will be schematically described. The HMI 31 includes an input device for a person to input data. The HMI 31 generates an input signal on the basis of the data and instruction input by the input device, and supplies the input signal to the respective units of the vehicle control system 11. The HMI 31 includes, as an input device, an operator such as a touch panel, a button, a switch, and a lever. The present disclosure is not limited thereto, and the HMI 31 may further include an input device capable of inputting information by a method other than the manual operation, e.g., voice or gesture. Further, for example, the HMI 31 may use, as an input device, a remote control device using infrared rays or radio waves, or an externally-connected device such as a movable device and a wearable device that support the operation of the vehicle control system 11.

The presentation of data by the HMI 31 will be schematically described. The HMI 31 generates visual information, auditory information, and haptic information for a passenger or the outside of the vehicle. Further, the HMI 31 performs output control of controlling the output, the output content, the output timing, and the output method of these pieces of generated information. The HMI 31 generates and outputs, as the visual information, an image or information indicated by light such as an operation screen, the state display of the vehicle 1, warning display, and a monitor image indicating the situation around the vehicle 1. Further, the HMI 31 generates and outputs, as the auditory information, information indicated by sounds such as voice guidance, a warning sound, and a warning message. Further, the HMI 31 generates and outputs, as the haptic information, information given to the haptic sensation of a passenger by, for example, force, vibration, or movement.

As the output device by which the HMI 31 outputs the visual information, for example, a display device that presents visual information by displaying an image by itself or a projector device that presents visual information by projecting an image can be applied. Note that the display device does not necessarily need to be a display device including a normal display and may be a device that displays visual information within the field of view of a passenger, such as a head-up display, a transmissive display, and a wearable device having an AR (Augmented Reality) function. Further, the HMI 31 may use, as an output device that outputs visual information, a display device included in a navigation device, an instrument panel, a CMS (Camera Monitoring System), an electronic mirror, a lamp, or the like provided in the vehicle 1.

As an output device by which the HMI 31 outputs auditory information, for example, an audio speaker, a headphone, or an earphone can be applied.

As an output device by which the HMI 31 outputs haptic information, for example, a haptic device using a haptic technology can be applied. The haptic device is provided at a portion of the vehicle 1 that a passenger touches, such as a steering wheel and a seat.

The vehicle control unit 32 controls the respective units of the vehicle 1. The vehicle control unit 32 includes the steering control unit 81, the brake control unit 82, the drive control unit 83, a body system control unit 84, a light control unit 85, and a horn control unit 86.

The steering control unit 81 detects and controls the state of the steering system of the vehicle 1, for example. The steering system includes, for example, a steering mechanism including a steering wheel and the like, an electric power steering, and the like. The steering control unit 81 includes, for example, a steering ECU that controls the steering system, an actuator that drives the steering system, and the like.

The brake control unit 82 detects and controls the state of the brake system of the vehicle 1, for example. The brake system includes, for example, a brake mechanism including a brake pedal and the like, an ABS (Antilock Brake System), a regenerative brake mechanism, and the like. The brake control unit 82 includes, for example, a brake ECU that controls the brake system, an actuator that drives the brake system, and the like.

The drive control unit 83 detects and controls the state of the drive system of the vehicle 1, for example. The drive system includes, for example, a drive-force generating device for generating a drive force, such as an accelerator pedal, an internal combustion engine, and a drive motor, a drive-force transmission mechanism for transmitting a drive force to wheels, and the like. The drive control unit 83 includes, for example, a drive ECU that controls the drive system, an actuator that drives the drive system, and the like.

The body system control unit 84 detects and controls the state of the body system of the vehicle 1, for example. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 detects and controls the state of various lights of the vehicle 1. As the light to be controlled, for example, a headlight, a backlight, a fog light, a turn signal, a brake light, a projection, a bumper display, and the like are assumed. The light control unit 85 includes a light ECU that controls the light, an actuator that drives the light, and the like.

The horn control unit 86 detects and controls the state of a car horn of the vehicle 1, for example. The horn control unit 86 includes, for example, a horn ECU that controls the car horn, an actuator that drives the car horn, and the like.

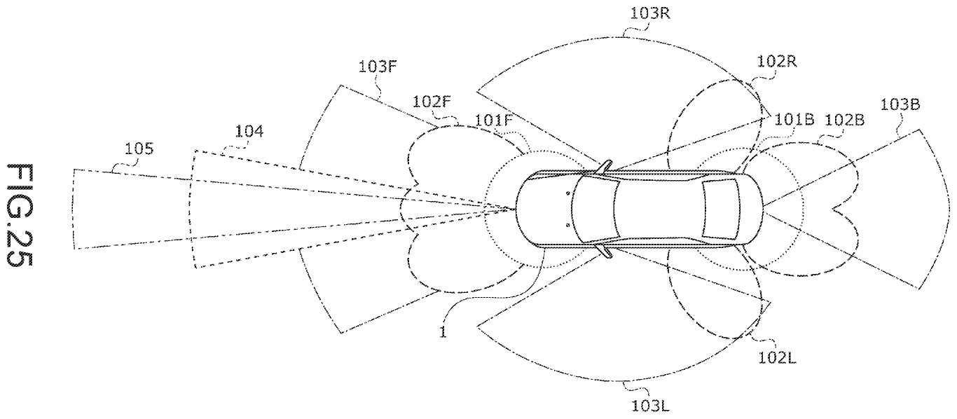

FIG. 25 is a diagram showing an example of a sensing region of the camera 51, the radar 52, the LiDAR 53, the ultrasonic sensor 54, and the like of the outside-recognizing sensor 25 shown in FIG. 24. Note that in FIG. 25, a state of the vehicle 1 viewed from the upper surface is schematically shown, the left end side is the front end (front) side of the vehicle 1, and the right end side is the rear end (rear) side of the vehicle 1.

A sensing region 101F and a sensing region 101B each show an example of the sensing region of the ultrasonic sensor 54. The sensing region 101F covers the periphery of the front end of the vehicle 1 by the plurality of ultrasonic sensors 54. The sensing region 101B covers the periphery of the rear end of the vehicle 1 by the plurality of ultrasonic sensors 54.

The sensing results in the sensing region 101F and the sensing region 101B are used for, for example, parking support of the vehicle 1.

A sensing region 102F to a sensing region 102B each show an example of the sensing region of the radar 52 for a short distance or middle distance. The sensing region 102F covers a range to a position farther than the sensing region 101F in front of the vehicle 1. The sensing region 102B covers a range to a position farther than the sensing region 101B behind the vehicle 1. The sensing region 102L covers the rear periphery of the vehicle 1 on the left side surface. The sensing region 102R covers the rear periphery of the vehicle 1 on the right side surface.

The sensing result in the sensing region 102F is used for, for example, detecting a vehicle or a pedestrian present in front of the vehicle 1. The sensing result in the sensing region 102B is used for, for example, a function of preventing collision behind the vehicle 1. The sensing results in the sensing region 102L and the sensing region 102R are used for, for example, detecting an object in a blind spot on the side of the vehicle 1.

A sensing region 103F to a sensing region 103B each show an example of the sensing region of the camera 51. The sensing region 103F covers a range to a position farther than the sensing region 102F in front of the vehicle 1. The sensing region 103B covers a range to a position farther than the sensing region 102B behind the vehicle 1. The sensing region 103L covers the periphery of the vehicle 1 on the left side surface. The sensing region 103R covers the periphery of the vehicle 1 on the right side surface.

The sensing result in the sensing region 103F can be used for, for example, recognition of a traffic light and a traffic sign, a lane deviation prevention support system, or an automatic headlight control system. The sensing result in the sensing region 103B can be used for, for example, parking support and a surround view system. The sensing results in the sensing region 103L and the sensing region 103R can be used for, for example, a surround view system.

A sensing region 104 shows an example of the sensing region of the LiDAR 53. The sensing region 104 covers a range to a position farther than the sensing region 103F in front of the vehicle 1. Meanwhile, the sensing region 104 has a narrower range in the right and left direction than the sensing region 103F.

The sensing result in the sensing region 104 is used for, for example, detecting an object such as a peripheral vehicle.

A sensing region 105 shows an example of the sensing region of the radar 52 for a long distance. The sensing region 105 covers a range to a position farther than the sensing region 104 in front of the vehicle 1. Meanwhile, the sensing region 105 has a narrower range in the right and left direction than the sensing region 104.

The sensing result in the sensing region 105 is used for, for example, ACC (Adaptive Cruise Control), emergency brake, collision avoidance.

Note that the sensing region of each sensor of the camera 51, the radar 52, the LiDAR 53, and the ultrasonic sensor 54 included in the outside-recognizing sensor 25 may have various configurations other than that shown in FIG. 2. Specifically, the ultrasonic sensor 54 may sense also the side of the vehicle 1, or the LiDAR 53 may sense the rear of the vehicle 1. Further, the installation position of each sensor is not limited to each of the above-mentioned examples. Further, the number of sensors may be one or two or more.

The present disclosure may also take the following configurations.

(1) A speed detection apparatus, including:
a transmission antenna array that transmits a plurality of chirp signals multiplexed between a plurality of transmission antennas;
a reception antenna array that includes a plurality of reception antennas receiving the plurality of chirp signals that has been reflected;
a chirp control unit that controls the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on the basis of the plurality of reflected chirp signals received by the plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra,
M representing a natural number of one or greater.

(2) The speed detection apparatus according to (1) above, in which
the chirp control unit multiplexes the plurality of chirp signals between the plurality of transmission antennas such that

$$TcL / TB > 1 / N$$

is satisfied,
TcL representing the longest interval of the intervals Tc between the plurality of chirp signals from the different transmission antennas.

(3) The speed detection apparatus according to (1) or (2) above, in which
the chirp control unit multiplexes the plurality of chirp signals between the plurality of transmission antennas in time division.

(4) The speed detection apparatus according to (1) or (2) above, in which
the chirp control unit multiplexes the plurality of chirp signals between the plurality of transmission antennas in phase division.

(5) The speed detection apparatus according to any one of (1) to (4) above, in which
the transmission antenna array and the reception antenna array constitute a horizontal MIMO array.

(6) The speed detection apparatus according to any one of (1) to (4) above, in which
the transmission antenna array and the reception antenna array constitute a vertical MIMO array.

(7) The speed detection apparatus according to (6) above, in which
the vertical MIMO array is a vertical MIMO array with equal intervals.

(8) The speed detection apparatus according to any one of (1) to (7) above, in which
the speed determination unit performs arrival angle estimation by fast Fourier transform (FFT) or discrete Fourier transform (DFT).

(9) The speed detection apparatus according to any one of (1) to (8) above, in which
the speed determination unit performs arrival angle estimation by CAPON, MUSIC, ESPRIT, or compression sensing.

(10) The speed detection apparatus according to (2) above, in which
the speed determination unit calculates M speed candidates from a plurality of possible speed candidates that can be taken in a speed width 2×Vmax×Nwrap obtained by Nwrap (Nwrap>N) and Vmax, Nwrap×(TcL/TB) being an integer multiple, M being larger than N, Nwrap being the number of speed wraps.

(11) The speed detection apparatus according to (2) above, in which
the speed determination unit selects and determines a speed at which a main lobe takes a maximum value, of the M arrival angle spectra, from the M speed candidates.

(12) The speed detection apparatus according to (2) above, in which
the speed determination unit selects and determines a speed at which a ratio between a main lobe and a side lobe takes a maximum value, of the M arrival angle spectra, from the M speed candidates.

(13) An information processing device, including:
a chirp control unit that controls a plurality of chirp signals transmitted from a plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on the basis of the plurality of reflected chirp signals received by a plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra,
M representing a natural number of one or greater.

(14) An information processing method, including:
controlling, in a speed detection apparatus that includes
   a transmission antenna array that transmits a plurality of chirp signals multiplexed between a plurality of transmission antennas, and
   a reception antenna array that includes a plurality of reception antennas receiving the plurality of chirp signals that has been reflected,
the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal;
calculating, on the basis of the plurality of reflected chirp signals received by the plurality of reception antennas, M speed candidates faster than a maximum speed Vmax obtained from the intervals TB;
acquiring M arrival angle spectra by performing phase error correction and arrival angle estimation on the M speed candidates; and
determining a true speed by processing the M arrival angle spectra,
M representing a natural number of one or greater.

Although embodiments of the present technology and modified examples have been described above, the present technology is not limited only to the above-mentioned embodiments and it goes without saying that various modifications can be made without departing from the essence of the present technology.

### REFERENCE SIGNS LIST

200 speed detection apparatus
210 information processing device
211 chirp control unit
212 speed determination unit
220 transmission antenna array
230 reception antenna array

1. A speed detection apparatus, comprising:
a transmission antenna array that transmits a plurality of chirp signals multiplexed between a plurality of transmission antennas;
a reception antenna array that includes a plurality of reception antennas receiving the plurality of chirp signals that has been reflected;
a chirp control unit that controls the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on a basis of the plurality of reflected chirp signals received by the plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra,
M representing a natural number of one or greater.

2. The speed detection apparatus according to claim 1, wherein
the chirp control unit multiplexes the plurality of chirp signals between the plurality of transmission antennas such that
$$TcL / TB > 1 / N$$
is satisfied,
TcL representing the longest interval of the intervals Tc between the plurality of chirp signals from the different transmission antennas.

3. The speed detection apparatus according to claim 1, wherein
the chirp control unit multiplexes the plurality of chirp signals between the plurality of transmission antennas in time division.

4. The speed detection apparatus according to claim 1, wherein
the chirp control unit multiplexes the plurality of chirp signals between the plurality of transmission antennas in phase division.

5. The speed detection apparatus according to claim 1, wherein
the transmission antenna array and the reception antenna array constitute a horizontal MIMO array.

6. The speed detection apparatus according to claim 1, wherein
the transmission antenna array and the reception antenna array constitute a vertical MIMO array.

7. The speed detection apparatus according to claim 6, wherein
the vertical MIMO array is a vertical MIMO array with equal intervals.

8. The speed detection apparatus according to claim 1, wherein
the speed determination unit performs arrival angle estimation by fast Fourier transform (FFT) or discrete Fourier transform (DFT).

9. The speed detection apparatus according to claim 1, wherein
the speed determination unit performs arrival angle estimation by CAPON, MUSIC, ESPRIT, or compression sensing.

10. The speed detection apparatus according to claim 2, wherein
the speed determination unit calculates M speed candidates from a plurality of possible speed candidates that can be taken in a speed width 2×Vmax×Nwrap obtained by Nwrap (Nwrap>N) and Vmax, Nwrap× (TcL/TB) being an integer multiple, M being larger than N, Nwrap being the number of speed wraps.

11. The speed detection apparatus according to claim 2, wherein
the speed determination unit selects and determines a speed at which a main lobe takes a maximum value, of the M arrival angle spectra, from the M speed candidates.

12. The speed detection apparatus according to claim 2, wherein
the speed determination unit selects and determines a speed at which a ratio between a main lobe and a side lobe takes a maximum value, of the M arrival angle spectra, from the M speed candidates.

13. An information processing device, comprising:
a chirp control unit that controls a plurality of chirp signals transmitted from a plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal; and
a speed determination unit that calculates, on a basis of the plurality of reflected chirp signals received by a plurality of reception antennas, M speed candidates faster than a maximum speed Vmax obtained from the intervals TB, acquires M arrival angle spectra by performing phase error correction and arrival angle estimation on the M speed candidates, and determines a true speed by processing the M arrival angle spectra,
M representing a natural number of one or greater.

14. An information processing method, comprising:
controlling, in a speed detection apparatus that includes
a transmission antenna array that transmits a plurality of chirp signals multiplexed between a plurality of transmission antennas, and
a reception antenna array that includes a plurality of reception antennas receiving the plurality of chirp signals that has been reflected,
the plurality of chirp signals transmitted from the plurality of transmission antennas such that when the plurality of chirp signals multiplexed between the plurality of transmission antennas is separated for each of the plurality of transmission antennas, intervals TB between the plurality of chirp signals from the same transmission antenna are equal and intervals Tc between the plurality of chirp signals from different transmission antennas are unequal;
calculating, on a basis of the plurality of reflected chirp signals received by the plurality of reception antennas, M speed candidates faster than a maximum speed Vmax obtained from the intervals TB;
acquiring M arrival angle spectra by performing phase error correction and arrival angle estimation on the M speed candidates; and
determining a true speed by processing the M arrival angle spectra,
M representing a natural number of one or greater.
